(19) United States
(12) Patent Application Publication
(10) Pub. No.: US 2025/0164798 A1
(43) Pub. Date: May 22, 2025

(54) Anamorphic Near-Eye Display Device

(71) Applicant: RealD Spark, LLC, BOULDER, CO (US)

(72) Inventors: Graham J. Woodgate, Henley-on-Thames (GB); Michael G. Robinson, BOULDER, CO (US); Jonathan Harrold, Leamington Spa (GB)

(21) Appl. No.: 18/947,126

(22) Filed: Nov. 14, 2024

Related U.S. Application Data
(60) Provisional application No. 63/601,355, filed on Nov. 21, 2023.
(60) Provisional application No. 63/551,624, filed on Feb. 9, 2024.
(60) Provisional application No. 63/603,834, filed on Nov. 29, 2023.

(51) Int. Cl. G02B 27/01; G02B 3/00; G02B 3/08; G02B 6/10; G02B 27/00; H04N 9/31

(52) U.S. Cl. CPC G02B 27/0172; G02B 3/08; G02B 6/105; G02B 27/0081; H04N 9/3105; H04N 9/3167; G02B 2003/0093; G02B 2027/011; G02B 2027/0178

(57) ABSTRACT

A display apparatus comprises anamorphic and non-anamorphic near-eye display apparatuses. The anamorphic display apparatus comprises a spatial light modulator with anamorphic pixels; an input transverse anamorphic lens; and an extraction waveguide comprising a lateral anamorphic light reversing reflector. Light from the spatial light modulator is imaged in the transverse direction by the transverse anamorphic lens, is input into the extraction waveguide and guided in a first direction along the waveguide. The light is imaged by a lateral anamorphic mirror in the lateral direction and directed in a second direction back through the waveguide. Features deflect the reflected light towards a viewer's pupil, maintaining the directionality of the fan of light rays from the spatial light modulator and anamorphic imaging system. The non-anamorphic near-eye display apparatus comprises a spatial light modulator with non-anamorphic pixels and a non-anamorphic lens arrangement that images the pixels through the extraction waveguide and towards the pupil.

### TECHNICAL FIELD

This disclosure generally relates to near-eye display apparatuses and illumination systems therefor.

### BACKGROUND

Head-worn displays incorporating a near-eye display apparatus may be arranged to provide fully immersive imagery such as in virtual reality (VR) displays or augmented imagery overlayed over views of the real world such as in augmented reality (AR) displays. If the overlayed imagery is aligned or registered with the real-world image it may be termed Mixed Reality (MR). In VR displays, the near-eye display apparatus is typically opaque to the real world, whereas in AR displays the optical system is partially transmissive to light from the real world.

The near-eye display apparatuses of AR and VR displays aim to provide images to at least one eye of a user with full colour, high resolution, high luminance and high contrast; and with wide fields of view (angular size of image), large eyebox sizes (the geometry over which the eye can move while having visibility of the full image field of view). Such displays are desirable in thin form factors, low weight and with low manufacturing cost and complexity.

Further, AR near-eye display apparatuses aim to have high transmission of light rays without image distortions or degradations and reduced glare of stray light away from the display wearer. AR optics may broadly be categorised as reflective combiner type or waveguide type. Waveguide types typically achieve reduced form factor and weight due to the optical path folding within the waveguide. Known methods for injecting images into a waveguide may use a spatial light modulator and a projection lens arrangement with a prism or grating to couple light into the waveguide. Pixel locations in the spatial light modulator are converted to a fan of ray directions by the projection lens. In other arrangements a laser scanner may provide the fan of ray directions. The angular locations are propagated through the waveguide and output to the eye of the user. The eye's optical system collects the angular locations and provides spatial images at the retina.

### BRIEF SUMMARY

According to a first aspect of the present disclosure, there is provided a near-eye display apparatus comprising: a first illumination system comprising a first spatial light modulator and a first optical apparatus, wherein the first spatial light modulator is arranged to output light via the first optical apparatus to provide a first image for display, wherein the first optical apparatus has an optical axis and positive optical power in lateral and transverse directions that are perpendicular to each other and perpendicular to the optical axis, and wherein the first optical apparatus has anamorphic properties in the lateral and transverse directions; and a second illumination system comprising a second spatial light modulator and a second optical apparatus, wherein the second spatial light modulator is arranged to output light via the second optical apparatus to provide a second image for display, and wherein the second optical apparatus has positive optical power for the light output by the second spatial light modulator, wherein the first illumination system is arranged to receive, from the second illumination system, light corresponding to the second image and to permit the received light corresponding to the second image to pass therethrough for display, and wherein the first image provided by the first spatial light modulator and first optical apparatus has at least one property that is different to the second image provided by the second spatial light modulator and second optical apparatus, wherein said at least one property comprises at least one of: image resolution; image content; brightness; exit pupil size; modulation transfer function; field of view; focal plane distance; response speed; pixel arrangement; and colour gamut.

A near-eye display apparatus may be provided with advantageously improved optical properties. Images with higher resolution may be provided. Different images may be provided on the first and second spatial light modulators that may be complementary. Background scenes may be merged with foreground image data. Retinal illuminance may be increased to achieve wider dynamic range and increased image realism. Image contrast may be improved to provide increased visibility of low-lights and high-lights in images. Freedom of eye movement may be improved when viewing an image. Image sharpness may be enhanced. Larger fields of view may be achieved. Images may be presented at different viewing distances. Improved temporal response may be achieved to reduce image lag. More colourful images may be provided with a wider colour gamut. Different images may be provided with different pixel arrangements to provide improved rendition of both text and natural images. The thickness increase of the display apparatus may be small. The first and second spatial light modulators may use different pixel technologies to advantageously achieve increased performance of the near-eye display apparatus at reduced cost.

The first optical apparatus may not provide optical power to the received light corresponding to the second image. Advantageously degradation of the second image may be reduced.

The first optical apparatus may comprise an extraction waveguide. Advantageously a small increase in thickness of the second illumination system by the first illumination system is achieved. A compact near-eye display apparatus may be provided. Light from the second illumination system may be efficiently transmitted through the waveguide to achieve improved system efficiency and reduced power consumption. Image brightness may be improved.

The second optical apparatus may have non-anamorphic properties in the lateral and transverse directions. Advantageously the cost and complexity of the second spatial light modulator may be reduced. The second optical apparatus may comprise a lens arrangement. Advantageously a low cost optical apparatus may be provided.

The first spatial light modulator may comprise first pixels distributed in the lateral direction, and the first optical apparatus may comprise: a transverse anamorphic component having positive optical power in the transverse direction, wherein the transverse anamorphic component is arranged to receive light from the first spatial light modulator and to output light in directions that are distributed in the transverse direction, wherein the extraction waveguide is arranged to receive the light output from the transverse anamorphic component. The first optical apparatus may further comprise a lateral anamorphic component having positive optical power in the lateral direction, wherein the extraction waveguide is arranged to guide light from the transverse anamorphic component to the lateral anamorphic component along the extraction waveguide in a first direction. The first optical apparatus may further comprise a light reversing reflector that is arranged to reflect light guided along the extraction waveguide in the first direction such that the reflected light is directed along the extraction waveguide in a second direction opposite to the first direction.

Advantageously a compact optical apparatus may be provided. In the lateral direction, a large exit pupil size may be achieved with low aberrations, achromatic imaging and high resolution. High efficiency may be provided and power consumption reduced. In the transverse direction a small lens width may be provided, reducing package size. The spatial light modulator may be provided over a smaller area than for the second spatial light modulator, reducing cost.

The extraction waveguide may comprise a rear guide surface and a polarisation-sensitive reflector opposing the rear guide surface; the first illumination system may further comprise a deflection arrangement disposed outside the polarisation-sensitive reflector, the first illumination system may be arranged to provide light guided along the extraction waveguide in the first direction with an input linear polarisation state before reaching the polarisation-sensitive reflector; the first optical apparatus may further comprise a polarisation conversion retarder disposed in the light path between the polarisation-sensitive reflector and the light reversing reflector, wherein the polarisation conversion retarder is arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder may have a linear polarisation state that is orthogonal to the input linear polarisation state; the polarisation-sensitive reflector may be arranged to reflect light guided in the first direction having the input linear polarisation state so that the rear guide surface and the polarisation-sensitive reflector are arranged to guide light in the first direction, and to extract light guided in the second direction having the orthogonal linear polarisation state so that the extracted light is incident on the deflection arrangement; and the deflection arrangement is arranged to deflect at least part of the light extracted by the polarisation-sensitive reflector that is incident thereon towards an output direction forwards of the first illumination system.

In operation, extracted light does not pass through the polarisation-sensitive reflector, advantageously stray light is reduced and efficiency improved. The extraction reflectors may be fabricated with low cost. Image uniformity for eye positions across the exit pupil may be improved.

The extraction waveguide may comprise: a front guide surface; a polarisation-sensitive reflector opposing the front guide surface; and an extraction element disposed outside the polarisation-sensitive reflector, the extraction element comprising: a rear guide surface opposing the front guide surface; and an array of extraction features; the first illumination system may be arranged to provide light guided along the extraction waveguide in the first direction with an input linear polarisation state before reaching the polarisation-sensitive reflector; and the first optical apparatus may further comprise a polarisation conversion retarder disposed between the polarisation-sensitive reflector and the light reversing reflector, wherein the polarisation conversion retarder is arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder may have an orthogonal linear polarisation state that is orthogonal to the input linear polarisation state; the polarisation-sensitive reflector is arranged to reflect light guided in the first direction having the input linear polarisation state and to extract light guided in the second direction having the orthogonal linear polarisation state, so that the front guide surface and the polarisation-sensitive reflector are arranged to guide light in the first direction, and the front guide surface and the rear guide surface are arranged to guide light in the second direction; and the array of extraction features is arranged to extract light guided along the extraction waveguide in the second direction towards an eye of a viewer through the front guide surface, the array of extraction features being distributed along the extraction waveguide so as to provide exit pupil expansion in the transverse direction.

The extraction element may be manufactured advantageously with low cost and complexity.

The extraction waveguide may comprise an array of extraction features disposed internally within the extraction waveguide, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion.

The rear and front light guide surfaces may be conveniently manufactured with high planarity and parallelism, advantageously achieving improved image resolution and contrast. Exit pupil uniformity from the first and second illumination systems may be improved.

The array of extraction features may comprise a reflectivity that is polarisation sensitive. Advantageously display efficiency may be increased. Reflection of light from the first illumination system into the second illumination system may be reduced, advantageously achieving increased image contrast.

The output polarisation state of light from the first optical apparatus may be orthogonal to the output polarisation state of light from the second optical apparatus. Advantageously the brightness of the near-eye display apparatus may be increased.

The lens arrangement may comprise a Fresnel lens. The lens arrangement may comprise a pancake lens. Advantageously aberrations may be improved and thickness reduced.

The first spatial light modulator may comprise first pixels. The first pixels may be inorganic micro-LED pixels or OLED pixels. Pixels with small pitch in the transverse direction and larger pitch in the lateral direction may achieve high luminous flux and with high resolution. Active silicon backplanes may be provided with low cost to achieve improved device functionality including response speed, resolution, and brightness.

The second spatial light modulator may comprise second pixels. The second pixels may be OLED pixels or the second pixels may be liquid crystal display pixels. Large size pixels may be provided to increase field of view while achieving desirable aberration performance.

An aspect ratio of the first pixels may be different to an aspect ratio of the second pixels. The aspect ratio of the pixels formed on the retina of the eye may be arranged to be similar to achieve desirable resolution characteristics on the retina.

A virtual image distance provided by the first optical apparatus may be different to a virtual image distance provided by the second optical apparatus. A foreground image and a background image may be conveniently provided. The background image may have obscuration or partially visible regions upon which the foreground image is overlaid. Advantageously improved image comfort may be achieved. Accommodation-vergence mismatch may be reduced.

According to a second aspect of the present disclosure, there is provided a head-worn display apparatus comprising: the near-eye display apparatus according to the first aspect; and a head-mounting arrangement for mounting the near-eye display apparatus on the head of a user. A comfortable light-weight head-mounted display apparatus may be provided. Stereoscopic images may further be provided to achieve increased image realism.

According to a third aspect of the present disclosure, there is provided a near-eye display apparatus comprising: a first illumination system comprising a first spatial light modulator and a first optical apparatus, wherein the first spatial light modulator is arranged to output light via the first optical apparatus to provide a first image for display, wherein the first optical apparatus has an optical axis and positive optical power in lateral and transverse directions that are perpendicular to each other and perpendicular to the optical axis, and wherein the first optical apparatus has non-anamorphic properties in the lateral and transverse directions; and a second illumination system comprising a second spatial light modulator and a second optical apparatus, wherein the second spatial light modulator is arranged to output light via the second optical apparatus to provide a second image for display, and wherein the second optical apparatus has positive optical power for the light output by the second spatial light modulator, wherein the first illumination system is arranged to receive, from the second illumination system, light corresponding to the second image and to permit the received light corresponding to the second image to pass therethrough for display wherein the second optical apparatus has non-anamorphic properties in the lateral and transverse directions, and wherein the first image provided by the first spatial light modulator and first optical apparatus has at least one property that is different to the second image provided by the second spatial light modulator and second optical apparatus, wherein said at least one property comprises at least one of: image resolution; image content; brightness; exit pupil size; modulation transfer function; field of view; focal plane distance; response speed; and colour gamut. By way of comparison with the first aspect, the cost and size of the first spatial light modulator may be reduced.

According to a fourth aspect of the present disclosure, there is provided a head-worn display apparatus comprising: the near-eye display apparatus according to the third aspect; and a head-mounting arrangement for mounting the near-eye display apparatus on the head of a user. A comfortable light-weight head-mounted display apparatus may be provided. Stereoscopic images may further be provided to achieve increased image realism.

Any of the aspects of the present disclosure may be applied in any combination.

Embodiments of the present disclosure may be used in a variety of optical systems. The embodiments may include or work with a variety of projectors, projection systems, optical components, displays, microdisplays, computer systems, processors, self-contained projector systems, visual and/or audio-visual systems and electrical and/or optical devices. Aspects of the present disclosure may be used with practically any apparatus related to optical and electrical devices, optical systems, presentation systems or any apparatus that may contain any type of optical system. Accordingly, embodiments of the present disclosure may be employed in optical systems, devices used in visual and/or optical presentations, visual peripherals and so on and in a number of computing environments and automotive environments.

Before proceeding to the disclosed embodiments in detail, it should be understood that the disclosure is not limited in its application or creation to the details of the particular arrangements shown, because the disclosure is capable of other embodiments. Moreover, aspects of the disclosure may be set forth in different combinations and arrangements to define embodiments unique in their own right. Also, the terminology used herein is for the purpose of description and not of limitation.

These and other advantages and features of the present disclosure will become apparent to those of ordinary skill in the art upon reading this disclosure in its entirety.

### BRIEF DESCRIPTION OF THE DRAWINGS

Embodiments are illustrated by way of example in the accompanying FIGURES, in which like reference numbers indicate similar parts, and in which:

FIG. 1 is a schematic diagram illustrating a rear perspective view of a near-eye display apparatus comprising an anamorphic display apparatus arranged to receive light from a non-anamorphic display apparatus;

FIG. 2A is a schematic diagram illustrating a rear perspective view of the anamorphic near-eye display apparatus of FIG. 1;

FIG. 2B is a schematic diagram illustrating a rear perspective view of the non-anamorphic near-eye display apparatus of FIG. 1;

FIG. 3 is a schematic diagram illustrating a side view of the operation of the near-eye display apparatus of FIG. 1;

FIG. 4A is a schematic diagram illustrating a side view of the operation in the transverse direction of the non-anamorphic near-eye display apparatus of FIG. 1;

FIG. 4B is a schematic diagram illustrating a top view of the operation in the lateral direction of the non-anamorphic near-eye display apparatus of FIG. 1;

FIG. 5A is a schematic diagram illustrating a side view of the anamorphic near-eye display apparatus of FIG. 1;

FIG. 5B is a schematic diagram illustrating a side view of light extraction and light transmission by the anamorphic near-eye display apparatus of FIG. 3A;

FIG. 5C is a schematic graph illustrating the variation of reflectivity for polarised light from a dichroic interface;

FIG. 6A is a schematic diagram illustrating a side view of a transverse eyebox provided by a single transverse anamorphic component comprising a lens stack;

FIG. 6B is a schematic diagram illustrating a side view of exit pupil expansion in the transverse direction of the anamorphic near-eye display apparatus of FIG. 1;

FIG. 7A is a schematic diagram illustrating a front perspective view of the operation in the transverse direction of the anamorphic near-eye display apparatus of FIG. 1;

FIG. 7B is a schematic diagram illustrating a front perspective view of the lateral eyebox provided by the lateral anamorphic component comprising a light reversing reflector;

FIG. 8A, FIG. 8B, and FIG. 8C are schematic diagrams illustrating in front views arrangements of anamorphic pixels of a spatial light modulator for use in the anamorphic illumination system of FIG. 1 and comprising spatially multiplexed red, green and blue sub-pixels;

FIG. 8D is a schematic diagram illustrating in front view an arrangement of anamorphic pixels of a spatial light modulator for use in the anamorphic illumination system of FIG. 1 wherein the red sub-pixels are larger than the green and blue sub-pixels;

FIG. 9A is a schematic diagram illustrating in front view an arrangement of non-anamorphic pixels of a spatial light modulator for use in the non-anamorphic illumination system of FIG. 1 and comprising spatially multiplexed red, green and blue non-anamorphic sub-pixels;

FIG. 9B is a schematic diagram illustrating in front view an arrangement of non-anamorphic pixels of a spatial light modulator for use in the non-anamorphic illumination system of FIG. 1 and comprising a hexagonal sub-pixel arrangement;

FIG. 10A is a schematic diagram illustrating in front view a spatial light modulator for use in the anamorphic near-eye display apparatus of FIG. 1;

FIG. 10B is a schematic diagram illustrating in front view a spatial light modulator for use in the non-anamorphic near-eye display apparatus of FIG. 1;

FIG. 10C is a schematic diagram illustrating in front view an intended retinal image from the anamorphic near-eye display apparatus of FIG. 1;

FIG. 10D is a schematic diagram illustrating in front view an intended retinal image from the non-anamorphic near-eye display apparatus of FIG. 1;

FIG. 10E is a schematic diagram illustrating in front view an alternative intended retinal image from the anamorphic near-eye display apparatus of FIG. 1;

FIG. 10F is a schematic diagram illustrating in front view an alternative intended retinal image from the non-anamorphic near-eye display apparatus of FIG. 1 overlaid with the intended retinal image of FIG. 10E of the anamorphic near-eye display apparatus;

FIG. 10G is a schematic diagram illustrating in front view an alternative intended retinal image from the anamorphic near-eye display apparatus of FIG. 1;

FIG. 10H is a schematic diagram illustrating in front view an alternative intended retinal image from the non-anamorphic near-eye display apparatus of FIG. 1;

FIG. 10I is a schematic diagram illustrating in front view alternative intended left-eye and right-eye retinal images from a head-worn display apparatus;

FIG. 11 is a schematic diagram illustrating a side view of retinal image formation for the anamorphic near-eye display apparatus of FIG. 1;

FIG. 12 is a schematic diagram illustrating a side view of retinal image formation for the non-anamorphic near-eye display apparatus of FIG. 1 wherein the virtual image is arranged at a finite distance from the eye;

FIG. 13A is a schematic diagram illustrating in side view an alternative near-eye display apparatus further comprising Pancharatnam-Berry lenses arranged to provide adjustable focal distances for virtual images from the anamorphic near-eye display apparatus and non-anamorphic near-eye display apparatus;

FIG. 13B is a schematic diagram illustrating in side view an alternative near-eye display apparatus further comprising Pancharatnam-Berry lenses arranged to provide adjustable focal distances for virtual images from non-anamorphic near-eye display apparatus;

FIG. 14A is a schematic diagram illustrating in side view input to the extraction waveguide comprising a laser sources and scanning arrangement;

FIG. 14B is a schematic diagram illustrating in front view a spatial light modulator arrangement comprising an array of laser light sources for use in the arrangement of FIG. 14A;

FIG. 14C is a schematic diagram illustrating in side view a spatial light modulator arrangement comprising an array of laser light sources, a beam expander and a scanning mirror;

FIG. 15A is a schematic diagram illustrating a rear perspective view of an alternative extraction arrangement of the anamorphic first illumination system of FIG. 2A;

FIG. 15B is a schematic diagram illustrating a rear perspective view of an alternative arrangement of the anamorphic first illumination system;

FIG. 15C is a schematic diagram illustrating a rear perspective view of an alternative extraction arrangement of the anamorphic first illumination system of FIG. 15A;

FIG. 15D is a schematic diagram illustrating a rear perspective view of an alternative extraction arrangement of the anamorphic first illumination system of FIG. 15B;

FIG. 15E is a schematic diagram illustrating a front view of the operation of the anamorphic first illumination system of FIG. 15C in a near-eye display apparatus;

FIG. 15F is a schematic diagram illustrating a side view of the operation of the anamorphic first illumination system of FIG. 15C in a near-eye display apparatus;

FIG. 16A is a schematic diagram illustrating a rear perspective view of an alternative anamorphic illumination system wherein the polarisation-sensitive reflector and extraction features are arranged on the rear guiding surface of the extraction waveguide;

FIG. 16B is a schematic diagram illustrating a side view of the anamorphic illumination system of FIG. 16A;

FIG. 17A is a schematic diagram illustrating a rear perspective view of an alternative anamorphic near-eye display apparatus wherein the extraction features extend between the front and rear guide surfaces;

FIG. 17B is a schematic diagram illustrating a rear perspective view of an alternative anamorphic near-eye display apparatus wherein the extraction features are stepped and are arranged between the guide surfaces of the extraction waveguide;

FIG. 17C is a schematic diagram illustrating a rear perspective view of an alternative anamorphic near-eye display apparatus wherein the extraction features are stepped and are arranged on the rear guide surface of the extraction waveguide;

FIG. 18A is a schematic diagram illustrating a rear perspective view of a near-eye display apparatus comprising an anamorphic illumination system arranged to receive light from a further anamorphic illumination system;

FIG. 18B is a schematic diagram illustrating a rear perspective view of a near-eye display apparatus comprising an anamorphic illumination system arranged to receive light from a further anamorphic illumination system and a non-anamorphic illumination system;

FIG. 19A is a schematic diagram illustrating a side view of the operation of an alternative arrangement of a near-eye display apparatus comprising an anamorphic near-eye display apparatus arranged to receive light from a non-anamorphic near-eye display apparatus comprising a Fresnel lens and clean-up polariser;

FIG. 19B is a schematic diagram illustrating a side view of the operation of an alternative arrangement of a near-eye display apparatus comprising an anamorphic near-eye display apparatus arranged to receive light from a non-anamorphic near-eye display apparatus comprising a Pancake lens;

FIG. 20 is a schematic diagram illustrating in rear perspective view an alternative backlight arrangement for a non-anamorphic near-eye display apparatus comprising a transmissive spatial light modulator;

FIG. 21 is a schematic diagram illustrating a rear perspective view of a near-eye display apparatus comprising a first non-anamorphic illumination system comprising an optical apparatus with internal extraction features arranged to receive light from a second non-anamorphic illumination system;

FIG. 22A is a schematic diagram illustrating a rear perspective view of a near-eye display apparatus comprising a first non-anamorphic illumination system comprising an optical apparatus with diffractive extraction features arranged to receive light from a second non-anamorphic illumination system;

FIG. 22B is a schematic diagram illustrating a side view of the operation of the first illumination system of FIG. 22A.

FIG. 23A is a schematic diagram illustrating a rear view of a head-worn display apparatus comprising a left-eye near-eye display apparatus and a right-eye near-eye display apparatus and a head-mounting arrangement; and

FIG. 23B is a schematic diagram illustrating a rear view of a head-worn display apparatus comprising a left-eye near-eye display apparatus and a right-eye near-eye display apparatus and a head-mounting arrangement wherein the right-eye near-eye display apparatus transmits light from external scenes.

### DETAILED DESCRIPTION

Terms related to optical retarders for the purposes of the present disclosure will now be described.

In a layer comprising a uniaxial birefringent material there is a direction governing the optical anisotropy whereas all directions perpendicular to it (or at a given angle to it) have equivalent birefringence.

The optical axis of an optical retarder refers to the direction of propagation of a light ray in the uniaxial birefringent material in which no birefringence is experienced. This is different from the optical axis of an optical system which may for example be parallel to a line of symmetry or normal to a display surface along which a principal ray propagates.

For light propagating in a direction orthogonal to the optical axis, the optical axis is the slow axis when linearly polarized light with an electric vector direction parallel to the slow axis travels at the slowest speed. The slow axis direction is the direction with the highest refractive index at the design wavelength. Similarly the fast axis direction is the direction with the lowest refractive index at the design wavelength.

For positive dielectric anisotropy uniaxial birefringent materials the slow axis direction is the extraordinary axis of the birefringent material. For negative dielectric anisotropy uniaxial birefringent materials the fast axis direction is the extraordinary axis of the birefringent material.

The terms half a wavelength and quarter a wavelength refer to the operation of a retarder for a design wavelength λ₀ that may typically be between 500 nm and 570 nm. In the present illustrative embodiments exemplary retardance values are provided for a wavelength of 550 nm unless otherwise specified.

The retarder provides a phase shift between two perpendicular polarization components of the light wave incident thereon and is characterized by the amount of relative phase, Γ, that it imparts on the two polarization components; which is related to the birefringence Δn and the thickness d of the retarder with retardance Δn·d by:

$$Γ = 2. π . Δ n . d / {λ}_{0} \qquad eqn . 1$$

In eqn. 1, Δn is defined as the difference between the extraordinary and the ordinary index of refraction, i.e.

$$Δ n = {n}_{e} - {n}_{o} \qquad eqn . 2$$

For a half-wave retarder, the relationship between d, Δn, and λ₀ is chosen so that the phase shift between polarization components is Γ=π. For a quarter-wave retarder, the relationship between d, Δn, and λ₀ is chosen so that the phase shift between polarization components is Γ=π/2.

Some aspects of the propagation of light rays through a transparent retarder between a pair of polarisers will now be described.

The state of polarisation (SOP) of a light ray is described by the relative amplitude and phase shift between any two orthogonal polarization components. Transparent retarders do not alter the relative amplitudes of these orthogonal polarisation components but act only on their relative phase. Providing a net phase shift between the orthogonal polarisation components alters the SOP whereas maintaining net relative phase preserves the SOP. In the current description, the SOP may be termed the polarisation state.

A linear SOP has a polarisation component with a non-zero amplitude and an orthogonal polarisation component which has zero amplitude. A p-polarisation state is a linear polarisation state that lies within the plane of incidence of a ray comprising the p-polarisation state and a s-polarisation state is a linear polarisation state that lies orthogonal to the plane of incidence of a ray comprising the p-polarisation state. For a linearly polarised SOP incident onto a retarder, the relative phase I is determined by the angle between the optical axis of the retarder and the direction of the polarisation component.

A linear polariser transmits a unique linear SOP that has a linear polarisation component parallel to the electric vector transmission direction of the linear polariser and attenuates light with a different SOP. The term “electric vector transmission direction” refers to a non-directional axis of the polariser parallel to which the electric vector of incident light is transmitted, even though the transmitted “electric vector” always has an instantaneous direction. The term “direction” is commonly used to describe this axis.

Absorbing polarisers are polarisers that absorb one polarisation component of incident light and transmit a second orthogonal polarisation component. Examples of absorbing linear polarisers are dichroic polarisers.

Reflective polarisers are polarisers that reflect one polarisation component of incident light and transmit a second orthogonal polarisation component. Examples of reflective polarisers that are linear polarisers are multilayer polymeric film stacks such as DBEF™ or APF™ from 3M Corporation, or wire grid polarisers such as ProFlux™ from Moxtek. Reflective linear polarisers may further comprise cholesteric reflective materials and a quarter-wave retarder arranged in series.

A retarder arranged between a linear polariser and a parallel linear analysing polariser that introduces no relative net phase shift provides full transmission of the light other than residual absorption within the linear polariser.

A retarder that provides a relative net phase shift between orthogonal polarisation components changes the SOP and provides attenuation at the analysing polariser.

Achromatic retarders may be provided wherein the material of the retarder is provided with a retardance Δn·d that varies with wavelength λ as

$$Δ n . d / λ = κ \qquad eqn . 3$$

where κ is substantially a constant.

Examples of suitable materials include modified polycarbonates from Teijin Films. Achromatic retarders may be provided in the present embodiments to advantageously minimise colour changes between polar angular viewing directions which have low luminance reduction and polar angular viewing directions which have increased luminance reductions as will be described below.

Various other terms used in the present disclosure related to retarders and to liquid crystals will now be described.

A liquid crystal cell has a retardance given by Δn·d where Δn is the birefringence of the liquid crystal material in the liquid crystal cell and d is the thickness of the liquid crystal cell, independent of the alignment of the liquid crystal material in the liquid crystal cell.

Homogeneous alignment refers to the alignment of liquid crystals in switchable liquid crystal displays where molecules align substantially parallel to a substrate. Homogeneous alignment is sometimes referred to as planar alignment. Homogeneous alignment may typically be provided with a small pre-tilt such as 2 degrees, so that the molecules at the surfaces of the alignment layers of the liquid crystal cell are slightly inclined as will be described below. Pretilt is arranged to minimise degeneracies in switching of cells.

In the present disclosure, homeotropic alignment is the state in which rod-like liquid crystalline molecules align substantially perpendicularly to the substrate. In discotic liquid crystals homeotropic alignment is defined as the state in which an axis of the column structure, which is formed by disc-like liquid crystalline molecules, aligns perpendicularly to a surface. In homeotropic alignment, pretilt is the tilt angle of the molecules that are close to the alignment layer and is typically close to 90 degrees and for example may be 88 degrees.

In a twisted liquid crystal layer, a twisted configuration (also known as a helical structure or helix) of nematic liquid crystal molecules is provided. The twist may be achieved by means of a non-parallel alignment of alignment layers. Further, cholesteric dopants may be added to the liquid crystal material to break degeneracy of the twist direction (clockwise or anti-clockwise) and to further control the pitch of the twist in the relaxed (typically undriven) state. A supertwisted liquid crystal layer has a twist of greater than 180 degrees. A twisted nematic layer used in spatial light modulators typically has a twist of 90 degrees.

Liquid crystal molecules with positive dielectric anisotropy are switched from a homogeneous alignment (such as an A-plate retarder orientation) to a homeotropic alignment (such as a C-plate or O-plate retarder orientation) by means of an applied electric field.

Liquid crystal molecules with negative dielectric anisotropy are switched from a homeotropic alignment (such as a C-plate or O-plate retarder orientation) to a homogeneous alignment (such as an A-plate retarder orientation) by means of an applied electric field.

Rod-like molecules have a positive birefringence so that nₑ>nₒ as described in eqn. 2. Discotic molecules have negative birefringence so that nₑ<nₒ.

Positive retarders such as A-plates, positive O-plates and positive C-plates may typically be provided by stretched films or rod-like liquid crystal molecules. Negative retarders such as negative C-plates may be provided by stretched films or discotic-like liquid crystal molecules.

Parallel liquid crystal cell alignment refers to the alignment direction of homogeneous alignment layers being parallel or more typically antiparallel. In the case of pre-tilted homeotropic alignment, the alignment layers may have components that are substantially parallel or antiparallel. Hybrid aligned liquid crystal cells may have one homogeneous alignment layer and one homeotropic alignment layer. Twisted liquid crystal cells may be provided by alignment layers that do not have parallel alignment, for example oriented at 90 degrees to each other.

The structure and operation of various near-eye display apparatuses will now be described. In this description, common elements have common reference numerals. It is noted that the disclosure relating to any element applies mutatis mutandi to each device in which the same or corresponding element is provided. Accordingly, for brevity such disclosure is not repeated. Similarly, the various features of any of the following examples may be combined together in any combination.

It would be desirable to provide a near-eye display apparatus 100 with a thin form factor, large freedom of movement, high resolution, high brightness and wide field of view. It would further be desirable to increase the performance of virtual reality display systems.

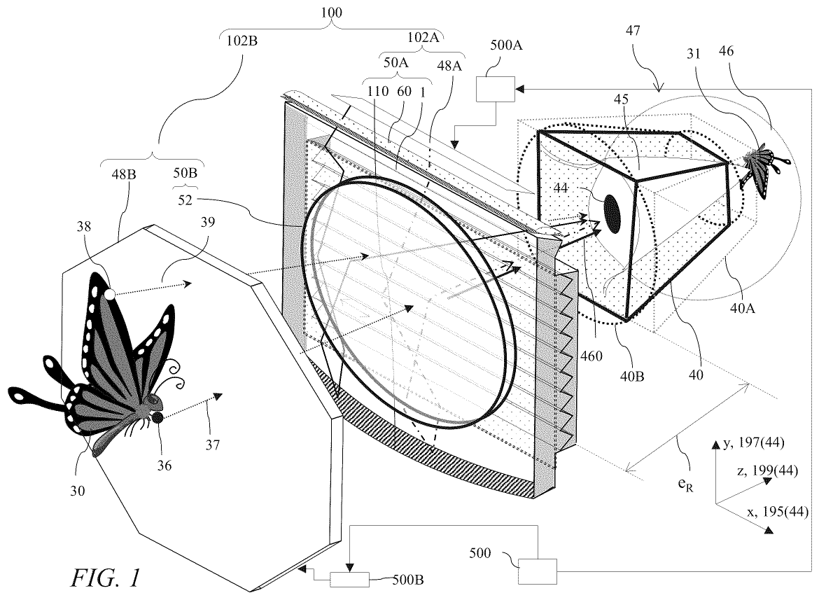

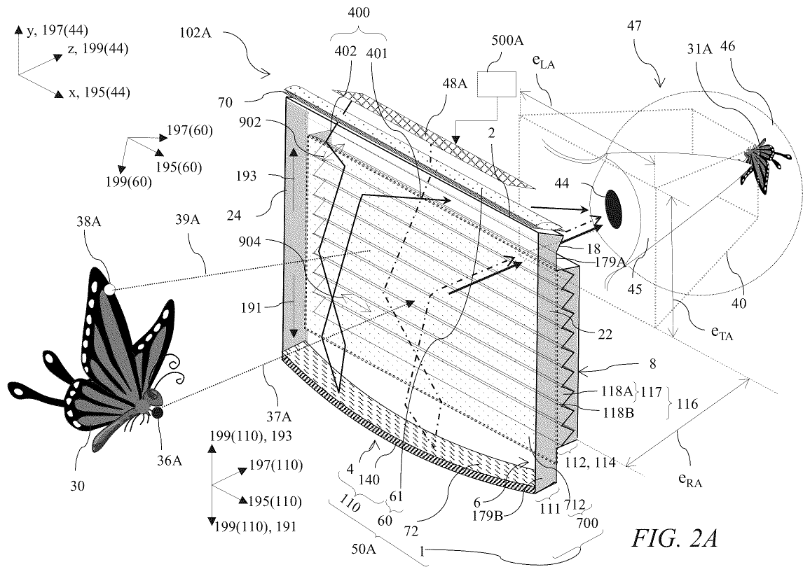

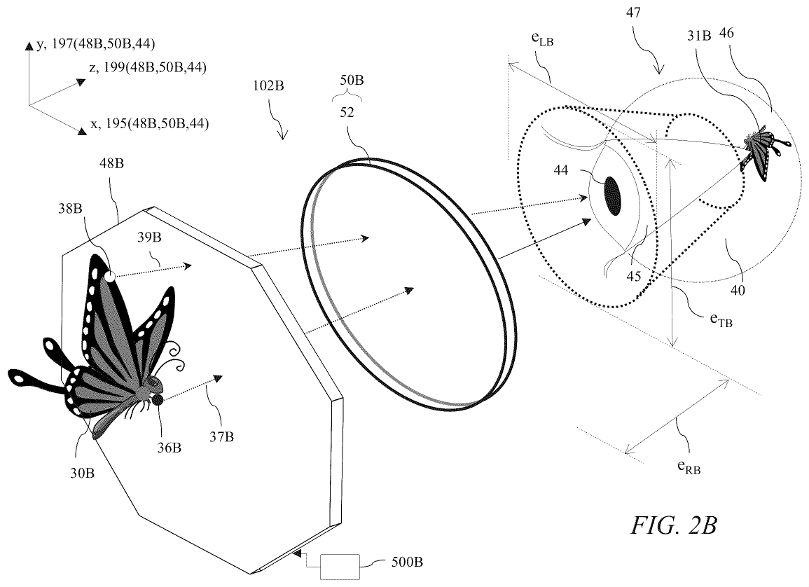

FIG. 1 is a schematic diagram illustrating a rear perspective view of a near-eye display apparatus 100 comprising a first illumination system 102A comprising an anamorphic display apparatus arranged to receive light from a non-anamorphic illumination system 102B. Features of the embodiment of FIG. 1 not discussed in further detail may be assumed to correspond to the features with equivalent reference numerals as discussed below and particularly with respect to FIGS. 2A-B, including any potential variations in the features.

FIG. 1 illustrates that the near-eye display apparatus 100 is provided near to an eye 45, to provide light to the pupil 44 of the eye 45 of a viewer 47.

The near-eye display apparatus 100 comprises: a first illumination system 102A comprising a first spatial light modulator 48A and a first optical apparatus 50A; and a second illumination system 102B comprising a second spatial light modulator 48B and a second optical apparatus 50B. The first spatial light modulator 48A is arranged to output light via the first optical apparatus 50A to provide a first image 30A for display; and the second spatial light modulator 48B is arranged to output light via the second optical apparatus 50B to provide a second image 30B for display. The image 30 provided to the eye 45 comprises first and second images 30A, 30B to provide a virtual image. Virtual image 30 is illustrated with on-axis virtual pixel 36 by providing an image 30 with virtual ray 37, and illustrative off-axis virtual pixel 38 by providing the image 30 with virtual ray 39. Virtual rays 37 and 39 are provided from output light rays 37A, 39A by the first illumination system 102A and as output light rays 37B, 39B by the second illumination system 102B.

The first optical apparatus 50A comprises an extraction waveguide 1, lateral anamorphic component 110 and transverse anamorphic component 60. In the illustrative embodiment of FIG. 1 the first optical apparatus may be termed an anamorphic optical apparatus 50A and the optical power in the lateral and transverse directions 195, 197 provided by the lateral anamorphic component 110 and transverse anamorphic component 60 respectively are different. The first optical apparatus 50A has an optical axis 199 and positive optical power in lateral direction 195 and transverse direction 197 that are perpendicular to each other and perpendicular to the optical axis 199 and has anamorphic properties in the lateral and transverse directions 195, 197.

The second optical apparatus 50B comprises a lens arrangement 52 and has positive optical power for the light output by the second spatial light modulator 48B. As will be described further hereinbelow, the second optical apparatus 50B may comprise one or more lenses with rotational symmetry of optical power that may comprise one or more surfaces with spherical or aspherical shape profiles. In the illustrative embodiment of FIG. 1 the second optical apparatus 50B may be termed a non-anamorphic optical apparatus 50B wherein optical powers are the same with respect to the lateral and transverse directions 195 (44), 197 (44) for light output towards the pupil 44 of the eye 45 wherein the optical powers are most typically rotationally symmetric.

In the near-eye display apparatus 100, pixels 222A of the first spatial light modulator 48A and pixels 222B of the second spatial light modulator 48B provide the first and second images 30A, 30B for the viewer's eye 45. The spatial image data provided with pixels 222A on spatial light modulators 48A is directed to the pupil 44 of the eye 45 as angular pixel data by means of optical apparatus 50A; and the spatial image data provided with pixels 222B on spatial light modulators 48B is directed to the pupil 44 of the eye 45 as angular pixel data by means of optical apparatus 50B as will be described hereinbelow.

In operation, the lens of the viewer's eye 45 relays the angular spatial image 30 to spatial pixel image 31 at the retina 46 of the eye 45 such that images 30A, 30B are provided by the near-eye display apparatus 100 to the viewer 47. In the description hereinbelow, angular image data (such as illustrated by virtual rays 37, 39) and retinal (spatial) image data (and not taking into account aberrations and vision corrections for the eye 45) may each be used to describe the optical output of images 30A, 30B from the near-eye display apparatus 100. The field of view is the angular distribution of image data provided by the display device 100 prior to focussing by the eye 45, and may be alternatively described by the spatial width of the retinal image 31.

The viewer's pupil 44 is located in a spatial volume near to the near-eye display apparatus 100 commonly referred to as the exit pupil 40, or eyebox. When the pupil 44 of the viewer 47 is located within the exit pupil 40, the eye 45 is provided with a full image without missing parts of the image 30, that is the image 30 does not appear to be vignetted at the retina 46.

In the embodiment of FIG. 1, the anamorphic illumination system 102A provides a first exit pupil 40A that may have a rectangular profile at the eye relief e_{RA}, and the non-anamorphic illumination system 102B provides a second exit pupil 40B that has a circular profile at the eye relief e_{RB}. The shape of the exit pupils 40A, 40B is determined at least by the anamorphic imaging properties of the anamorphic near-eye display apparatus and the respective aberrations of the anamorphic and non-anamorphic optical systems. The exit pupil 40 of the near-eye display apparatus 100 is formed in the region of the overlap of the first and second exit pupils 40A, 40B.

The exit pupil 40 at a nominal eye relief distance e_{R} may have dimension e_{L} in the lateral direction 195 and dimension e_{T} in the transverse direction 197. The maximum eye relief distance e_{Rmax} refers to the maximum distance of the pupil 44 from the anamorphic first illumination system 102A wherein no image vignetting is present. In the present embodiment, increasing the size of the exit pupil 40 refers to increasing the dimensions e_{L}, e_{T}. Increased exit pupil 40 achieves an increased viewer freedom and an increase in e_{Rmax} as will be described further hereinbelow with reference to FIGS. 6A-B for example.

In an illustrative embodiment, the eye 45 may be arranged at a nominal viewing distance e_{R} of between 5 mm and 100 mm and preferably between 8 mm and 25 mm from the output surface of the anamorphic first illumination system 102A. Such displays are distinct from direct view displays wherein the viewing distance is typically greater than 100 mm. The nominal viewing distance e_{R} may be referred to as the eye relief.

The near-eye display apparatus 100 further comprises a control apparatus 500 arranged to operate the spatial light modulators 48A, 48B by means of display controllers 500A, 500B to provide light that is spatially modulated in accordance with image data representing images 30A, 30B.

As will be described further hereinbelow, the near-eye display apparatus 100 of FIG. 1 may be arranged to provide desirably increased optical performance to that achievable by the first and second illumination systems 102A, 102B individually including at least one of improved (i) image resolution; (ii) image content (iii) brightness; (iv) exit pupil size; (v) modulation transfer function; (vi) field of view; (vii) focal plane distance; (viii) response speed; (ix) pixel arrangement; and (x) colour gamut.

In the present disclosure image resolution may refer to the spatial density of the pixel information on the spatial light modulator 48, the angular density of the pixel information that is output from the second light guide surface 8 of the illumination system 102A or the spatial density of the pixel information of the retinal image 31 at the retina 46 that is achieved by viewing the display apparatus 100.

The structure and operation of the first illumination system 102A comprising the anamorphic first optical apparatus 50A will now be described.

FIG. 2A is a schematic diagram illustrating a rear perspective view of the anamorphic illumination system 102A of FIG. 1. Features of the embodiment of FIG. 2A not discussed in further detail may be assumed to correspond to the features with equivalent reference numerals as discussed above, including any potential variations in the features.

Anamorphic near-eye display devices that are similar in structure to the first illumination system 102A of FIG. 2A, and alternative embodiments therein and operation thereof are described in further detail in U.S. patent application Ser. No. 18/734,222 filed Jun. 5, 2024 (Atty. Ref. No. 502001), which is herein incorporated by reference in its entirety.

The first optical apparatus 50A comprises the first spatial light modulator 48A, the transverse anamorphic component 60 and an extraction waveguide 1 comprising the lateral anamorphic component 110.

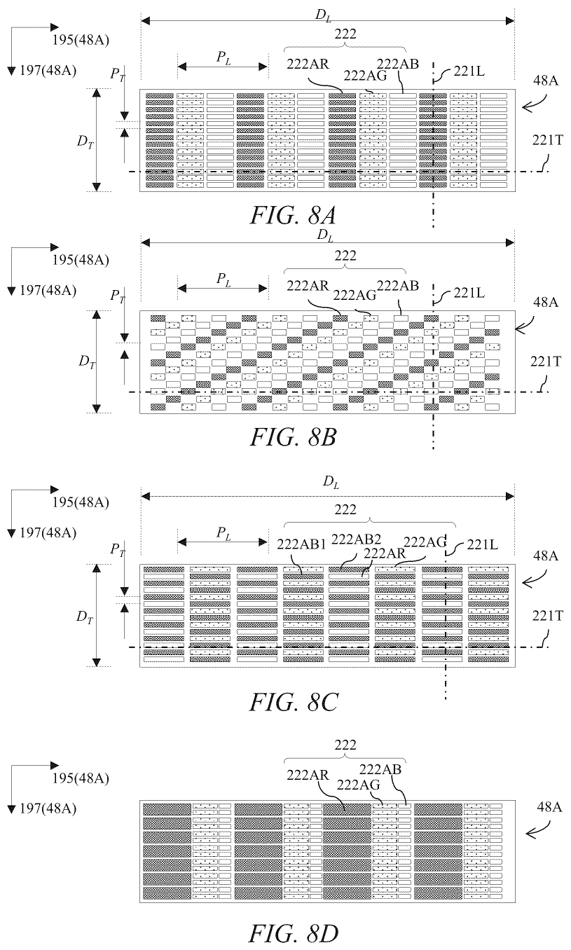

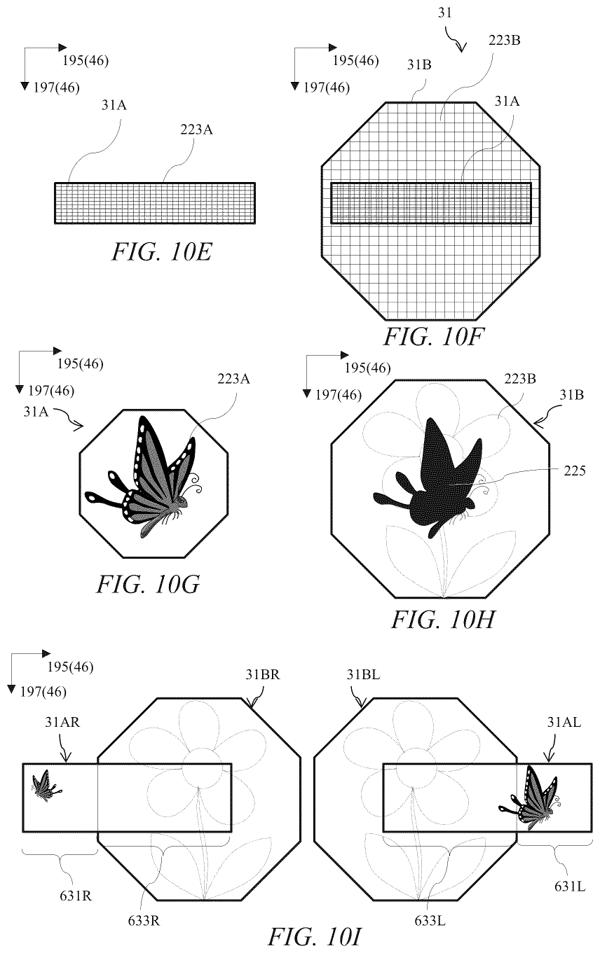

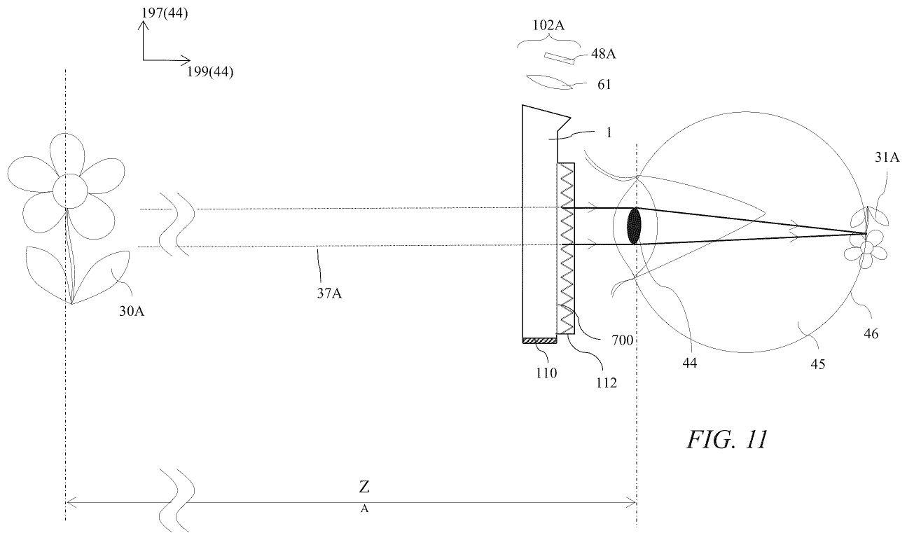

The first spatial light modulator 48A comprises first pixels 222A distributed in the lateral direction 195 (48A) and will be described further hereinbelow with respect to FIGS. 8A-C and FIG. 10A for example.

The transverse anamorphic component 60 is arranged to receive light rays 400 from the spatial light modulator 48A. The transverse anamorphic component 60 has positive optical power in the transverse direction 197 and is extended in a lateral direction 195 (60) parallel to the lateral direction 195 (48A) of the spatial light modulator 48A. The optical apparatus 50A is arranged so that light output from the transverse anamorphic component 60 is directed in directions that are distributed in the transverse direction 197 (60) at the transverse anamorphic component 60. In the embodiment of FIG. 2A, the transverse anamorphic component 60 comprises transverse lens 61, wherein in the embodiment of FIG. 1 the transverse lens 61 comprises a cylindrical lens. The transverse anamorphic component 60 that is lens 61 has positive optical power in a transverse direction 197 (60) that is parallel to the direction at the spatial light modulator 48 that is termed the direction 197 (48A) and orthogonal to the lateral direction 195 (60); and no optical power in the lateral direction 195 (60).

In the present disclosure, the term lens most generally refers to a single lens element or a compound lens (group of lens elements) as will be described hereinbelow in FIG. 6B for example; and is arranged to provide optical power. A lens may comprise a single refractive surface, multiple refractive surfaces, reflective surfaces or may comprise a catadioptric lens element that combines refractive and reflective surfaces. A lens may further or alternatively comprise diffractive optical elements. A transverse lens is a lens that provides optical power in the transverse direction. Typically a transverse lens provides no optical power in the lateral direction. A transverse lens may be termed a cylindrical lens, although the profile in cross section of the surface or surfaces providing optical power may be different to a segment of a circle, for example paraboidal, elliptical or aspheric.

The extraction waveguide 1 is arranged to receive light from the transverse anamorphic component 60 and to guide light rays 400 from the transverse lens 61 to the lateral anamorphic component 110 along the extraction waveguide 1 in a first direction 191.

The lateral anamorphic component 110 has positive optical power in the lateral direction 195 (110) at the lateral anamorphic component 110. Light reversing reflector 140 comprises a reflective material and is arranged to reflect light guided along the extraction waveguide 1 in the first direction 191 such that the reflected light is directed along the extraction waveguide 1 in a second direction 193 opposite to the first direction 191. In the embodiment of FIG. 2A, the light reversing reflector 140 is a reflective end 4 of the extraction waveguide 1. Furthermore, the lateral anamorphic component 110 comprises the light reversing reflector 140. The reflective end 4 of the extraction waveguide 1 has a curved shape in the lateral direction 195 that provides positive optical power, affecting the light rays in the lateral direction 195 (110), and no power in the transverse direction 197 (110). The optical apparatus 50A is thus arranged so that light output from the lateral anamorphic component 110 is directed in directions that are distributed in the transverse direction 197 (110) and the lateral direction 195 (110). The curved shape of the reflective end 4 may be a shape that is the cross section of a sphere, ellipse, parabola or other aspheric shape to achieve desirable imaging of light rays from the spatial light modulator 48 to the pupil 44 of the eye 45 as will be described further hereinbelow. The reflective material may be a reflective film such as ESR™ from 3M or may be an evaporated or sputtered metal material such as aluminium or silver.

The extraction waveguide 1 comprises a rear guide surface 6 and a polarisation-sensitive reflector 700 opposing the rear guide surface 6. The extraction waveguide 1 comprises waveguide member 111 arranged between the rear guide surface 6 and the polarisation-sensitive reflector 700, wherein light guides through the waveguide member 111 in the first direction 191.

The extraction waveguide 1 has an input end 2 extending in the lateral and transverse directions 195 (60), 197 (60). The extraction waveguide 1 further comprises waveguide member 111 that is arranged to receive light 400 from the spatial light modulator 48A through the input end 2. The input end 2 extends in the lateral direction 195 between edges 22, 24 of the extraction waveguide 1, and extends in the transverse direction between opposing surfaces of the extraction waveguide 1 waveguide member 111.

A tapered surface 18 is provided to direct light cones into the waveguide 1 in the transverse direction 197 that are offset in angle from the direction 191 in which the waveguide 1 is extended. Advantageously the appearance of double images may be reduced or eliminated.

The extraction waveguide 1 further comprises a deflection arrangement 112 disposed outside the polarisation-sensitive reflector 700, in other words the polarisation-sensitive reflector 700 is arranged between the deflection arrangement 112 and waveguide member 111.

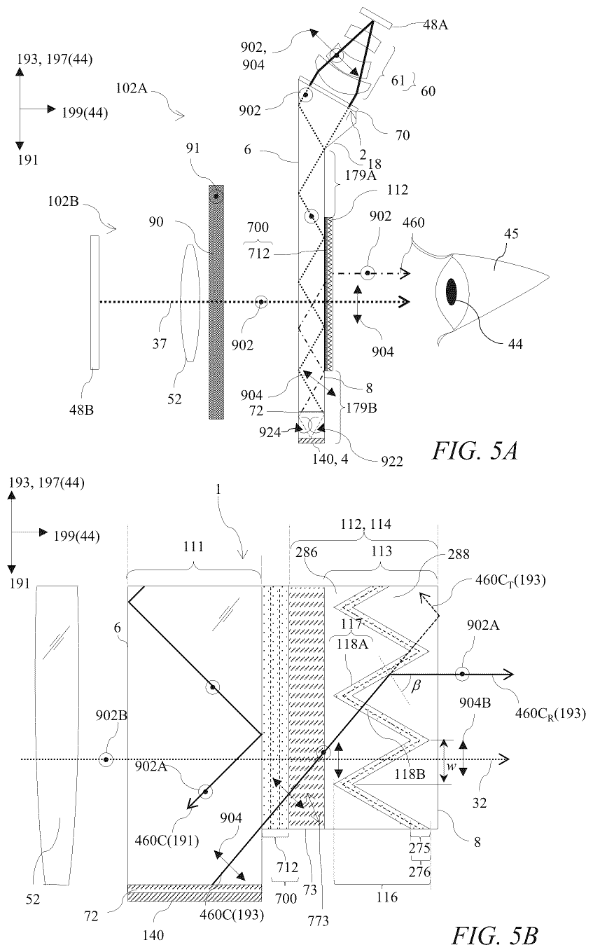

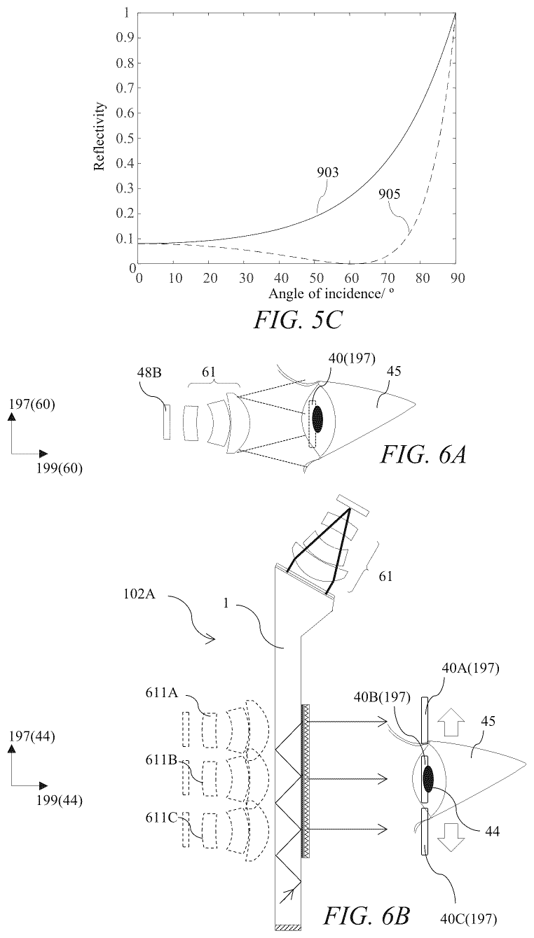

The deflection arrangement 112 comprises a deflection element 116 comprising an array of deflection features 118A that are arranged to deflect light incident thereon towards the output direction 199 (44) wherein the deflection features 118A are reflectors 117 as will be described further in FIG. 5B hereinbelow. The deflection element 116 is arranged to direct the deflected light towards a viewer's eye 45 in front of the anamorphic directional illumination device 100.

The principle of operation of the first illumination system 102A will now be further described. The optical apparatus 50A has an optical axis 199A and has anamorphic properties in a lateral direction 195A and in a transverse direction 197A that are perpendicular to each other and perpendicular to the optical axis 199.

Mathematically expressed, for any location within the anamorphic first illumination system 102A, the optical axis direction 199 may be referred to as the O unit vector, the transverse direction 197 may be referred to as the T unit vector and the lateral direction 195 may be referred to as the L unit vector wherein the optical axis direction 199 is the crossed product of the transverse direction 197 and the lateral direction 195:

$$O = T \times L \qquad eqn . 4$$

Various surfaces of the anamorphic first illumination system 102A transform or replicate the optical axis direction 199; however, for any given ray, the expression of eqn. 4 may be applied. In the present description, the lateral and transverse directions 195, 197 are defined relative to the optical axis 199A direction in any part of the spatial light modulator 48A or optical apparatus 50A, and are not in constant directions in space. In the embodiment of FIG. 2A, the transverse direction 197 (60) illustrates the transverse direction 197 at the transverse anamorphic component 60 formed by the transverse lens 61; the transverse direction 197 (110) illustrates the transverse direction 197 at the lateral anamorphic component 110; and the transverse direction 197 (44) illustrates the transverse direction 197 towards the pupil 44 at the eye 45 of the viewer 47. The transverse anamorphic component 60 has lateral direction 195 (60) that is the same as the lateral direction 195 (110) of the lateral anamorphic component 110 and the lateral direction 195 (44) at the pupil 44 of the eye 45. The Euclidian coordinate system illustrated by x, y, z directions is invariant, whereas the transverse direction 197, lateral direction 195 and optical axis direction 199 may be transformed at various optical components, in particular by reflection from optical components, of the anamorphic first illumination system 102A.

The structure and operation of a second illumination system 102B comprising a second optical apparatus 50B that is non-anamorphic will now be described.

FIG. 2B is a schematic diagram illustrating a rear perspective view of the non-anamorphic second illumination system 102B of FIG. 1. Features of the embodiment of FIG. 2B not discussed in further detail may be assumed to correspond to the features with equivalent reference numerals as discussed above, including any potential variations in the features.

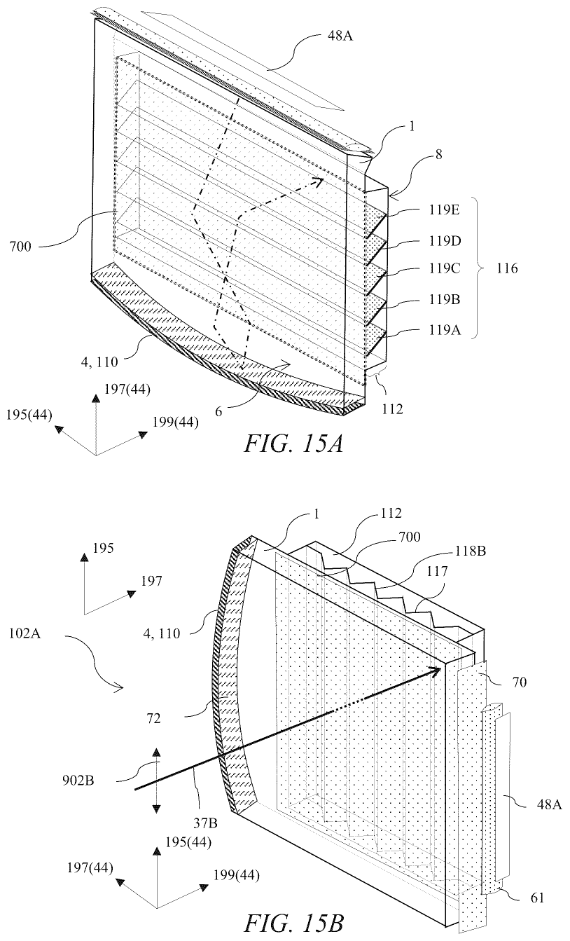

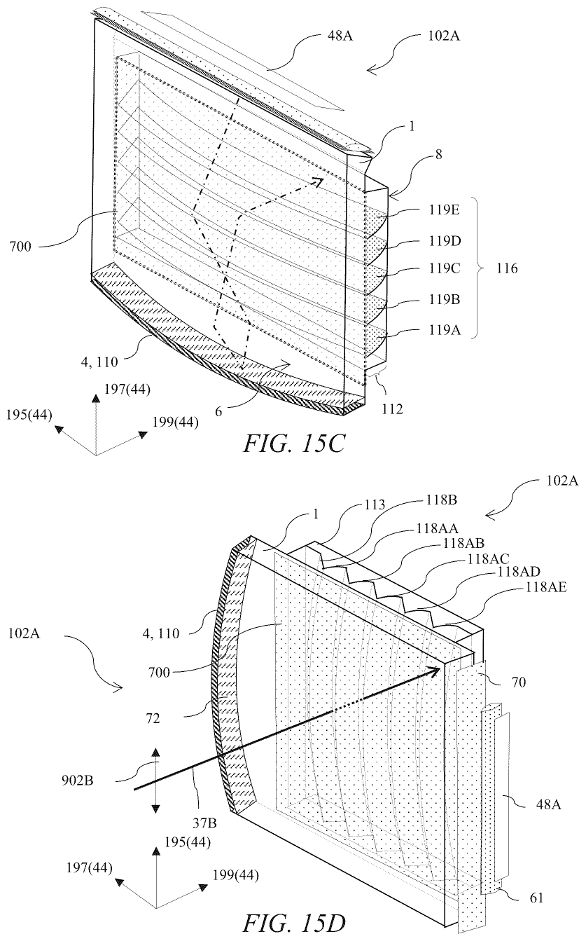

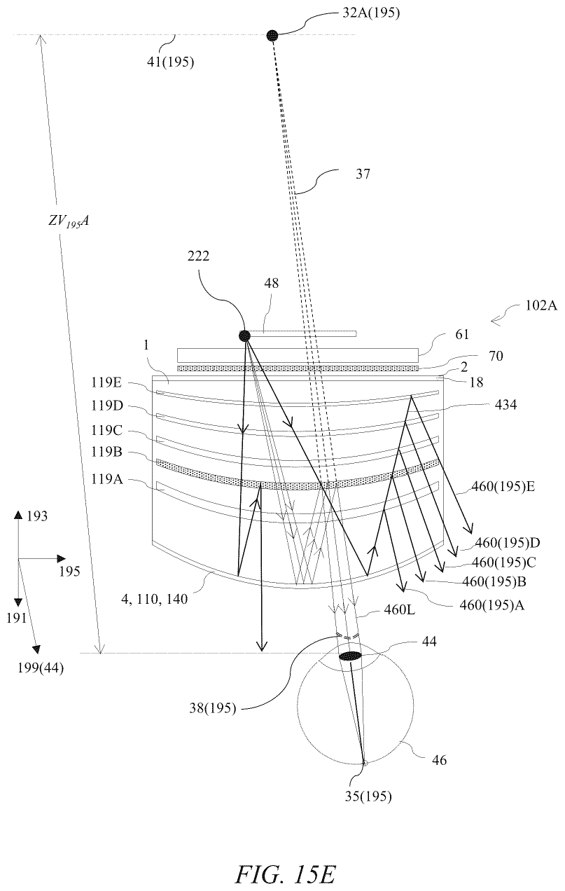

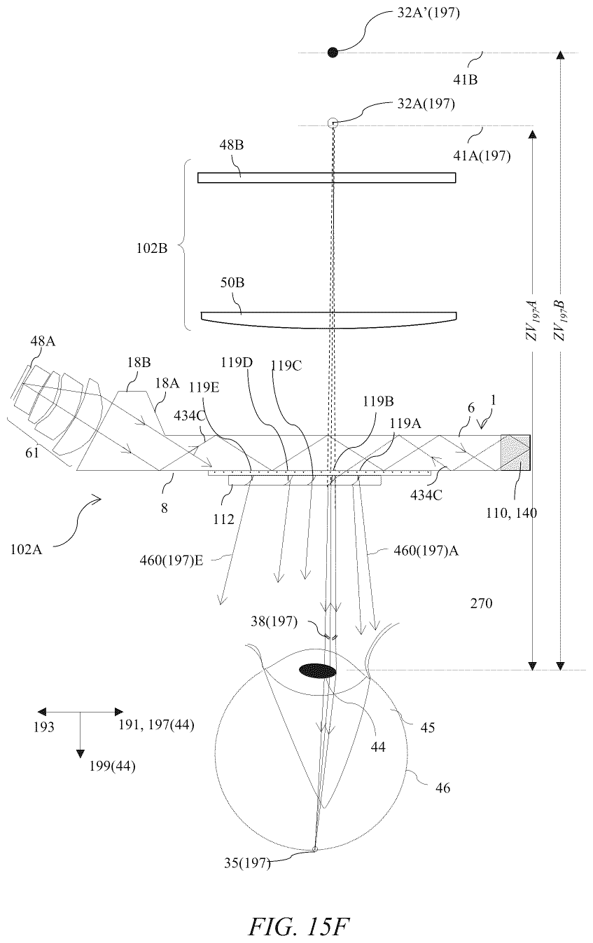

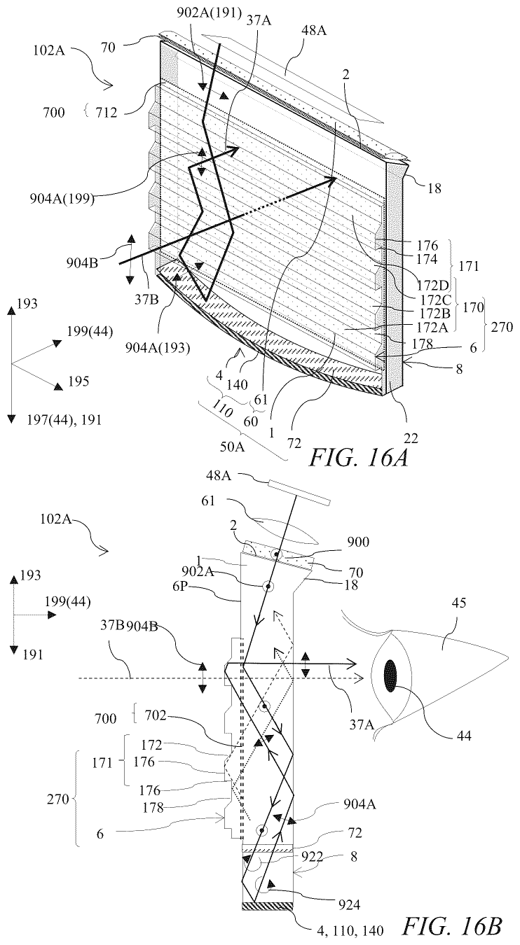

By way of comparison with FIG. 2A, the second optical apparatus 50B is provided by a non-anamorphic optical system which is a lens arrangement 52 that has rotationally symmetric optical power properties. Further, the spatial light modulator 48B comprises pixels 222B that are imaged in a non-anamorphic manner, that is pixels 222B with a given aspect ratio are imaged to image points in the image 31B on the retina 46 that have the same given aspect ratio. The lens arrangement 52 may comprise glass or plastic lenses that may be singlets or compound lenses. Alternative embodiments of the second optical apparatus 50B are described in FIGS. 15-16 hereinbelow. The spatial light modulator 48B typically has a different size to the spatial light modulator 48A, and the pixels 222B are different in size to the pixels 222A. As will be described hereinbelow, the light emission and light control structure of the pixels 222B may be different to the light emission and light control structure of the pixels 222A.

Considering the directions of operation of the second illumination system 102B, lateral directions 195 (48B), 195 (50B) are the same; the transverse directions 197 (48B), 197 (50B) are the same and may be the same as the directions 195 (44), 197 (44).

The content of the image 31B may be similar to the content of image 31A, or may have at least one difference including: (i) different image resolution; (ii) different retinal illuminance; (iii) different modulation transfer function; (iv) different contrast; (v) different field of view; (vi) may be arranged in at least one focal plane that is different to the at least one focal plane; (vii) different response speeds; (viii) different pixel arrangements; and (ix) different colour gamuts as will be described further hereinbelow. Advantageously increased functionality of the retinal image 31 may be achieved.

The operation of the near-eye display apparatus 100 of FIG. 1 will now be further described.

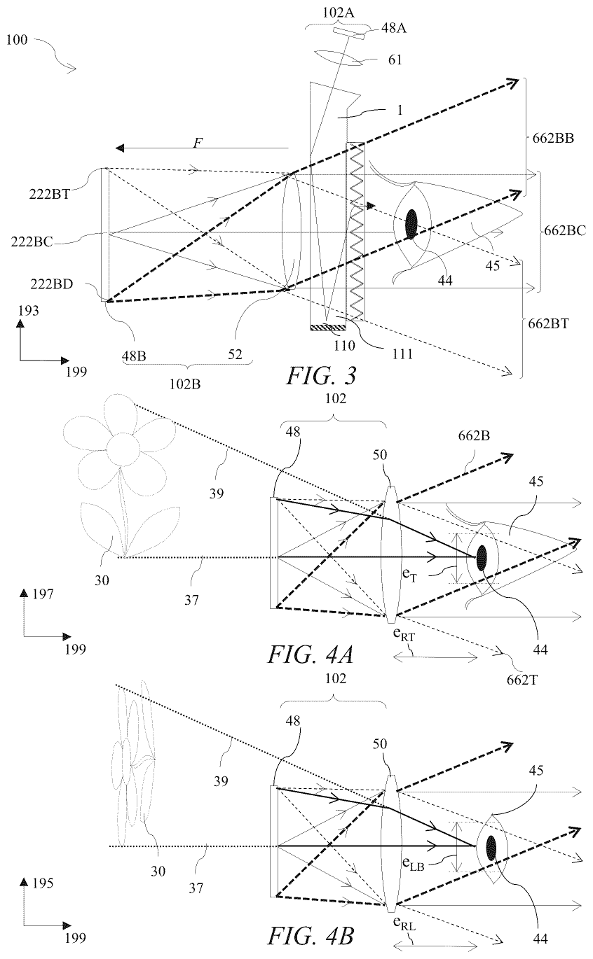

FIG. 3 is a schematic diagram illustrating a side view of the operation of the near-eye display apparatus 100 of FIG. 1. Features of the embodiment of FIG. 3 not discussed in further detail may be assumed to correspond to the features with equivalent reference numerals as discussed above, including any potential variations in the features.

The first illumination system 102A is arranged to receive, from the second illumination system 102B, light corresponding to the second image 30B and to permit the received light corresponding to the second image 30B to pass therethrough for display. In other words, the first optical apparatus 50A allows the received light corresponding to the second image 30B to pass though it without converging or diverging the light.

The first optical apparatus 50A does not provide optical power to the received light corresponding to the second image 30B. Spatial light modulator 48B comprises a top pixel 222BT, central pixel 222BC and bottom pixel 222BD. Lens 52 is arranged at or near its focal length F from the spatial light modulator 48B so that ray bundles 662BT, 662BC and 662BB are output towards the eye 45 of the viewer. The ray bundles are not substantially deflected by the first optical apparatus 50A, so that an image 31B is formed at the retina 46 of the eye 45. Advantageously image fidelity and focal plane location of the image 31B are maintained.

The propagation of polarised light from the spatial light modulator 48B through the anamorphic optical apparatus 50A will be described herein below with respect to FIG. 5A.

Virtual image 30 formation will now be described.

FIG. 4A is a schematic diagram illustrating a side view of the operation in the transverse direction 197 of the near-eye display apparatus 100 of FIG. 1; and FIG. 4B is a schematic diagram illustrating a top view of the operation in the lateral direction 195 of the near-eye display apparatus 100 of FIG. 1. Features of the embodiment of FIGS. 4A-B not discussed in further detail may be assumed to correspond to the features with equivalent reference numerals as discussed above, including any potential variations in the features.

FIGS. 4A-B illustrate that virtual image 30 is provided by the ray bundles 662 from the optical apparatus 50. For the purposes of FIGS. 4A-B, the anamorphic optical apparatus 50A and the non-anamorphic optical apparatus 50B may be considered schematically as operating in a similar manner although the optical systems 50A, 50B have different structures.

Virtual rays 37, 39 are seen by the eye 45. If the spatial light modulator 48 is at the focal plane of the optical apparatus 50, the virtual image is located at infinity. Desirably the focal plane may be provided at a closer distance, for example 2m. In that case, the lens 52 of the optical apparatus 50B may have increased optical power. Advantageously more comfortable viewing geometry may be provided for image 30B.

The eyebox 40 sizes e_{T}, e_{L} and eye reliefs e_{RT} and e_{RL} are provided by the overlap of respective beams 662T, 662B, so that images 30 are perceived that are not vignetted.

The structure and operation of the first optical apparatus 50A will now be considered in further detail.

FIG. 5A is a schematic diagram illustrating a side view of the anamorphic illumination system 102A of FIG. 1. Features of the embodiment of FIG. 5A not discussed in further detail may be assumed to correspond to the features with equivalent reference numerals as discussed above, including any potential variations in the features.

The spatial light modulator 48A may output polarised light with linear polarisation state 902 or unpolarised light with resolved polarisation components 902, 904. The optical apparatus 50A may comprise an input linear polariser 70 disposed between the spatial light modulator 48A and the reflectors 117 and disposed between the spatial light modulator 48 and the polarisation-sensitive reflector 700 of the extraction waveguide 1; and is arranged to pass light having the input linear polarisation state 902.

The input linear polariser 70 is arranged between the transverse anamorphic component 60 and the extraction waveguide 1. The input linear polariser 70 is an absorbing polariser such as a dichroic iodine polariser arranged to transmit a linear polarisation state and absorb the orthogonal polarisation state. In alternative embodiments the linear polariser 70 may be arranged between the transverse anamorphic component 60 and the spatial light modulator 48 or may be the output polariser of the spatial light modulator 48.

The extraction waveguide 1 comprises a rear guide surface 6 and a polarisation-sensitive reflector 700 opposing the rear guide surface 6. The first illumination system 102A further comprises a deflection arrangement 112 disposed outside the polarisation-sensitive reflector 700, the first illumination system 102A is arranged to provide light guided along the extraction waveguide 1 in the first direction 191 with an input linear polarisation state 902 before reaching the polarisation-sensitive reflector 700.

One example of a polarisation-sensitive reflector 700 is a dichroic stack 712. Other types of polarisation-sensitive reflector 700 include reflective linear polarisers such as wire grid polarisers or liquid crystal layers.

The polarisation-sensitive reflector 700 may not extend along the entirety of the waveguide member 111. Waveguide member 111 guiding regions 179A, 179B may be arranged along the waveguide member 111 between an input end 2 and the polarisation-sensitive reflector 700, and between the polarisation-sensitive reflector 700 and light reversing reflector 140. The front guide surface 8 of the extraction waveguide 1 may comprise the guiding regions 179A, 179B.

The polarisation-sensitive reflector 700 is arranged to reflect light guided in the first direction 191 having the input linear polarisation state 902 so that the rear guide surface 6 and the polarisation-sensitive reflector 700 are arranged to guide light in the first direction 191, and to extract light guided in the second direction 193 having the orthogonal linear polarisation state so that the extracted light is incident on the deflection arrangement 112.

Further the optical apparatus 50A may comprise a polarisation conversion retarder 72 disposed between the light reversing reflector 140 and the deflection arrangement 112 that may be an A-plate with an optical axis direction arranged to convert linearly polarised light 902 to circularly polarised light 922 and circularly polarised light 924 to linearly polarised light 904. In other words the polarisation conversion retarder 72 is arranged to convert a polarisation state of light passing therethrough between a linear polarisation state and a circular polarisation state, and the polarisation conversion retarder 72 and the light reversing reflector 140 are arranged in combination to rotate the input linear polarisation state 902 of the light guided in the first direction 191 so that the light guided in the second direction 193 and output from the polarisation conversion retarder 72 has a linear polarisation state 904 that is orthogonal to the input linear polarisation state 902.

The deflection arrangement 112 is arranged to deflect at least part of the light extracted by the polarisation-sensitive reflector 700 that is incident thereon towards an output direction 199 (44) forwards of the first illumination system 102A.

The extraction of light from the extraction waveguide 1 will now be considered further.

FIG. 5B is a schematic diagram illustrating a side view of light extraction and light transmission by the anamorphic illumination system 102A of FIG. 3A; and FIG. 5C is a schematic graph illustrating the variation of reflectivity for polarised light from a dichroic interface. Features of the embodiment of FIGS. 5B-C not discussed in further detail may be assumed to correspond to the features with equivalent reference numerals as discussed above, including any potential variations in the features.

FIG. 5B illustrates a detail of light ray 460C (193) that is reflected by the light reversing reflector 140.

The polarisation-sensitive reflector 700 is arranged to pass light 460C (193) guided in the second direction 193 having the orthogonal linear polarisation state 904 so that the passed light is incident on the deflection element 116. Thus the input linear polarisation state of ray 460C (191) is an s-polarisation state 902 in the extraction waveguide 1, and the ray 460C (193) has the orthogonal linear polarisation state that is a p-polarisation state 904 in the extraction waveguide. Advantageously high efficiency of transmission for light propagating in the first direction 191 along the extraction waveguide 1, and high efficiency of extraction for light propagating in the second direction 193 may be achieved.

The first optical apparatus 50A further comprises an intermediate polarisation conversion retarder 73 arranged between the polarisation-sensitive reflector 700 and the deflection element 116, the intermediate polarisation conversion retarder 73 being arranged to convert a polarisation state of light passing therethrough between the orthogonal linear polarisation state 904 and the linear polarisation state 902.

Light incident in the second direction 193 onto the polarisation-sensitive reflector 700 has a polarisation state 904, and the light is transmitted by the polarisation-sensitive reflector 700. The intermediate polarisation conversion retarder 73 has an optical axis direction 773 and outputs the s-polarisation state 902 which is incident onto the deflection arrangement 112.

FIG. 5B illustrates a front waveguide 114, deflection arrangement 112 comprising deflection elements 116 comprising deflection features 118A and draft facet 118B wherein the reflector 117 comprises the deflection feature 118A. Front waveguide 114 has a front guide surface 8 on the opposite side from the polarisation-sensitive reflector 700 of the front waveguide 114.

TABLE 1 shows an illustrative embodiment of the geometry of the arrangement of FIGS. 5A-B for an extraction waveguide 1 refractive index of 1.5.

TABLE 1

| Angle compared to direction 191 along | Illustrative |
|---|---|
| the extraction waveguide 1 | embodiment |
| Input end 2 inclination, δ | 60° |
| Tapered surface 18 inclination, χ | 44° |
| Cone 491_{T} half angle in the material | 10° |
| of the extraction waveguide, τ | |
| Reflector 117 tilt angle, β | 60° |
| Draft facet 118B tilt angle, α | 60° |
| Angle of incidence of central output | 90° |
| ray 460C at output surface 8, κ | |

The deflection features 118A are disposed internally within the front waveguide 114. In the embodiment of FIG. 5B, the deflection arrangement 112 and the front waveguide 114 each comprise the polarisation conversion retarder 73, and the deflection arrangement member 113 comprising the front element 288, the rear element 286 and a dichroic stack 276.

The front waveguide 114 comprises a front element 288 and a rear element 286 having a partially reflective layer 275 disposed therebetween wherein the partially reflective layer 275 comprises a dichroic stack 276.

FIG. 5C illustrates an example of Fresnel reflectivities 903, 905 for s-polarised light polarisation state 902 and p-polarised light polarisation state 904 respectively at a single interface between SiO₂ and TiO₂. At Brewster's angle, the reflectivity of p-polarised light polarisation state 904 is close to zero and so light is transmitted by the dichroic stack 276 and s-polarised light polarisation state 902 is at least partially reflected. By comparison, for on-axis incidence, such as at the dichroic stack 712, light rays are transmitted for both polarisation states 902, 904. Dielectric stack 712 comprises multiple dielectric layers 714A-E with an illustrative embodiment in TABLE 2.

TABLE 2

| | Illustrative | Refractive | Thickness |
|---|---|---|---|
| Item | material | index | (nm) |
| Waveguide member 11A | PMMA | 1.50 | — |
| Dielectric layer 714A | TiO₂ | 2.6 | 54 |
| Dielectric layer 714B | SiO₂ | 1.5 | 181 |
| Dielectric layer 714C | TiO₂ | 2.6 | 55 |
| Dielectric layer 714D | SiO₂ | 1.5 | 181 |
| Dielectric layer 714E | TiO₂ | 2.6 | 55 |
| Waveguide member 11B | PMMA | 1.49 | — |

The partially reflective layer 275 comprises first and second sections of opposite inclination alternating in a direction 193 along the front waveguide 114, the first sections comprising deflection feature 118A that is a reflective reflector 117 and the second sections comprising draft facet 118B arranged to pass the light passed by the polarisation-sensitive reflector 700 that is incident thereon.

The deflection features 118A and transmission features 118B are elongate in the lateral direction 195, to provide a wide exit pupil 40 size in the lateral direction 195.

The deflection features 118A of the deflection element 116 comprise sections that are separated in a direction 193 along the front waveguide 114 to provide exit pupil 40 expansion in the transverse direction 197. The reflectors 117 of the deflection features 118A are partially reflective reflectors 117, each comprising a partially reflective layer 275.

The deflection arrangement 112 is arranged to deflect at least part of the light 460C_{R}(193) passed by the polarisation-sensitive reflector 700 that is incident thereon towards an output direction 199(44) forwards of the anamorphic directional illumination device 100.

Alternatively or additionally, the partially reflective layer 275 may comprise a metallic partially reflective layer. Advantageously the uniformity and efficiency of deflection may be improved.

The light deflection arrangement 112 may be formed by depositing the dielectric layers 714 of the dichroic stack 276 onto the front or rear elements 288, 286 that may be prismatic films. After deposition of the dichroic stack 276, a planarization layer 288 may be provided for the other of the front or rear elements 288, 286, and further providing the front guide surface 8 or a surface for attachment to the intermediate polarisation control retarder 73.

Referring to FIG. 5C, at the deflection feature 118A, the angle of incidence β is near to the Brewster angle, in an illustrative example β is 60 degrees, and at least some of the light with the polarisation state 902 is reflected towards the eye 45 of the user as light ray 463C_{R}(193). As the deflection feature 118A comprises a partially reflective layer 275 and some of the light may further be transmitted as light ray 463C_{T}(193) to achieve eyebox 40A expansion.

The dichroic stacks 712, 276 may be conveniently provided by dichroic material deposition with low cost. The dichroic stacks 712, 276 may be provided by the same coating stack design to achieve desirable light propagation properties, advantageously providing reduced cost of manufacture. The dielectric stack of TABLE 2 may further be provided for the polarisation-sensitive reflector 712 to advantageously reduce system coating costs.

The size w of the reflector 117 may be arranged to minimise diffractive blur in the image seen by the user. Advantageously improved fidelity of image quality may be achieved.

In the present description, partial reflectivity may refer to layers such as dichroic stacks 712, 276 (or reflective polarisers 702 for example) that transmit some light for both polarisation states, or transmit one polarisation state and substantially reflect the orthogonal polarisation state. Typically the s-polarisation state 902 may have higher reflectivity than the p-polarisation state 904 at dichroic stacks.

The second optical apparatus 50B provides an output polarisation state 902B that may be provided by the spatial light modulator 48B or may be provided by an input polariser 90 as illustrated in FIG. 5A with electric vector transmission direction 91.

The polarisation state 902B is rotated to polarisation state 904B by the intermediate polarisation conversion retarder 73 and is transmitted at least in part by the dielectric stack 276 of the reflector 117 and the draft facet 118B of the deflection element 116 without deflection; and output through the front guide surface 8 towards the eye 45. The output polarisation state 904A of light from the first optical apparatus 50A is orthogonal to the output polarisation state 902B of light from the second optical apparatus 50B to achieve images 30A, 30B with brightness that may be added to advantageously provide increased retinal illuminance of combined image 30.

Exit pupil 40 expansion in the transverse direction 197 will now be described for the first optical apparatus 50A.

FIG. 6A is a schematic diagram illustrating a side view of a transverse exit pupil 40 provided by a single transverse anamorphic component 60 comprising a lens stack 61; and FIG. 6B is a schematic diagram illustrating a side view of exit pupil 40 expansion in the transverse direction 197 of the anamorphic illumination system 102A of FIG. 1. Features of the embodiment of FIGS. 6A-B not discussed in further detail may be assumed to correspond to the features with equivalent reference numerals as discussed above, including any potential variations in the features.

FIG. 6A illustrates the transverse eyebox 40 (197) that would be achieved if a single lens 61 were to be directed by the first optical apparatus 50 to the eye 45. Such eyebox 40 (197) would be limited in size by the size of the lens 61. It is desirable to provide eyebox 40 (197) expansion in the transverse direction 197.

For illustrative purposes FIG. 6B shows multiple images 611A, 611B, 611C of the lens 61 that are provided by the rays 460C_{T}(193) of FIG. 5B which in turn provides replication of resulting exit pupils 40A (197), 40B (197), 40C (197). Advantageously eyebox 40(197) total size is increased, and image vignetting is reduced for desirable eye movement.

Propagation of polarised light through the first optical apparatus 50 will now be described with reference to the lateral direction 195.

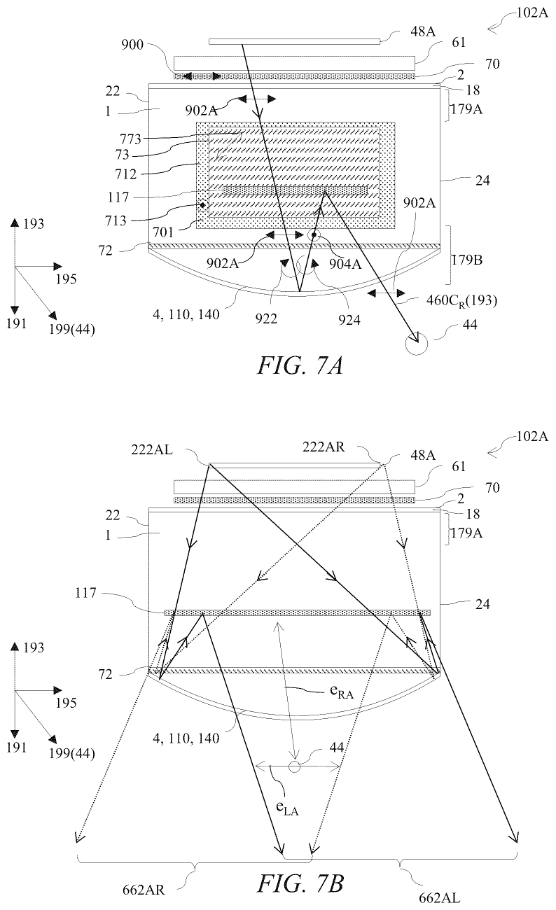

FIG. 7A is a schematic diagram illustrating a front perspective view of the operation in the transverse direction 197 of the anamorphic illumination system 102A of FIG. 1. Features of the embodiment of FIG. 7A not discussed in further detail may be assumed to correspond to the features with equivalent reference numerals as discussed above, including any potential variations in the features.

FIG. 7A illustrates ray 460C_{R}(193) of FIG. 5B that has input polarisation state 902A is output with orthogonal polarisation state 904A after the polarisation state rotations of retarders 72, 73 respectively.

Formation of exit pupil 40 for the lateral direction 195 will now be described for the first optical apparatus 50A.

FIG. 7B is a schematic diagram illustrating front perspective view of the lateral exit pupil 40 provided by the lateral anamorphic component 110 comprising a light reversing reflector 140. Features of the embodiment of FIG. 7B not discussed in further detail may be assumed to correspond to the features with equivalent reference numerals as discussed above, including any potential variations in the features.

FIG. 7B illustrates the propagation of light rays from left side pixel 222AL and right side pixel 222AR of the spatial light modulator 48A. The lateral anamorphic component 110 provides ray bundles 662AL, 662AR respectively. Exit pupil 40A (195) has size e_{LA} at the eye relief e_{RA}. The lateral anamorphic component 110 has a width determined by the width of the extraction waveguide 1 and anamorphic illumination system 102A thus provides a large exit pupil that does not require the pupil expansion approach in the transverse direction 197 of FIG. 7A. Advantageously brightness and image uniformity is increased in comparison to optical waveguides that require pupil expansion in both lateral and transverse directions 195, 197.

Illustrative arrangements of first pixels 222A of the spatially multiplexed spatial light modulator 48A will now be described.

FIGS. 8A-C are schematic diagrams illustrating in front view arrangements of anamorphic first pixels 222A of a first spatial light modulator 48A for use in the anamorphic illumination system 102A of FIG. 1 and comprising spatially multiplexed red, green and blue sub-pixels 222AR, 222AG, 222AB; and FIG. 8D is a schematic diagram illustrating in front view an arrangement of anamorphic pixels 222A of a spatial light modulator 48A for use in the anamorphic illumination system 102A of FIG. 1 wherein the red sub-pixels 222AR are larger than the green 222AG and blue sub-pixels 222AB. Features of the embodiments of FIGS. 8A-D not discussed in further detail may be assumed to correspond to the features with equivalent reference numerals as discussed above, including any potential variations in the features.

The first spatial light modulator 48A may be a transmissive spatial light modulator such as a TFT-LCD further comprising a backlight. Alternatively the first spatial light modulator 48A may be a reflective spatial light modulator such as Liquid Crystal on Silicon (LCOS) or a Microoptoelectromechanical (MOEMS) array of micro-mirrors such as the DMD from Texas Instruments. Alternatively the first spatial light modulator 48A may be an emissive spatial light modulator using material systems such as OLED or inorganic micro-LED. A silicon backplane may be provided to achieve high speed addressing of high resolution arrays of first pixels 222A.

In FIGS. 8A-C, the first pixels 222A of the first spatial light modulator 48A are distributed in the lateral direction 195 (48A) and also distributed in the transverse direction 197 (48A) so that the light output from the transverse anamorphic component 60 is directed in the directions that are distributed in the transverse direction 197 and the light output from the lateral anamorphic component 110 is directed in the directions that are distributed in the lateral direction 195 when output towards the pupil 44 of the eye 45.

White first pixels 222A comprising red, green and blue sub-pixels 222AR, 222AG, 222AB are provided spatially separated in the lateral direction 195 and the sub-pixels 222AR, 222AG, 222AB are elongate with a pitch P_{L} in the lateral direction that is greater than the pitch P_{T} in the transverse direction 197.

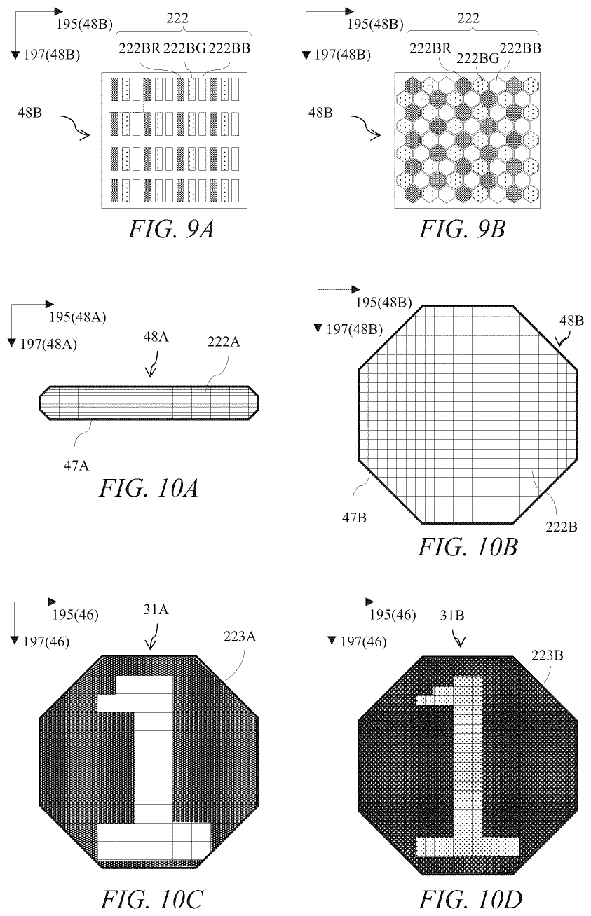

Considering FIGS. 1C-D and the embodiments of FIGS. 8A-C for the first spatial light modulator 48A and FIG. 9A for the second spatial light modulator 48B, it may be desirable to provide square white pixels in the final perceived virtual image 34 from the retinal image 31. The pitch P_{L} is magnified by the lateral anamorphic component to an angular size ϕ_{L} (with spatial pitch δ_{L} at the retina 46) and the pitch P_{T} is magnified by the transverse anamorphic component to an angular size ϕ_{T} (with spatial pitch δ_{T} at the retina 46). The pitches P_{L}, P_{T} may be determined by said different angular magnifications to advantageously achieve square angular pixels from the anamorphic first illumination system 102A.

The first pixels 222A are arranged as columns 221L, wherein the columns 221L are distributed in the lateral direction 195, and the pixels along the columns 221L are distributed in the transverse direction 197; and the first pixels 222A are further arranged as rows 221T, wherein the rows 221T are distributed in the transverse direction 197, and the pixels along the rows 221T are distributed in the lateral direction 195.

In the anamorphic first illumination system 102A of the present embodiments, the distance f_{T} between the first principal plane of the transverse anamorphic component 60 of the optical apparatus 50A is different to the distance f_{L} between the first principal plane of the lateral anamorphic component 110 of the optical apparatus 50A. Similarly, for a square output field of view (ϕ_{T} is the same as ϕ_{L}), the separation D_{T} of pixels 222T, 222D in the transverse direction is different to the separation DL of pixels 222R, 222L in the lateral direction 195.

In the present description, the lateral angular magnification M_{L} provided by the lateral anamorphic component 110 of the optical apparatus 50A may be given as

$${M}_{L} = ϕ {p}_{L} / {p}_{L} \qquad eqn . 5$$

and the transverse angular magnification M_{T} provided by the transverse anamorphic component 60 of the optical apparatus 50A may be given as:

$${M}_{T} = ϕ {p}_{T} / {P}_{T} \qquad eqn . 6$$

where ϕp_{L} is the angular size of a virtual pixel 36 seen by the eye in the lateral direction 195, P_{L} is the pixel pitch in the lateral direction 195, ϕp_{T} is the angular size of a virtual pixel 36 seen by the eye in the transverse direction 197, and P_{T} is the pixel pitch in the transverse direction 197. In the case that the angular virtual pixels 36 are square, then ϕp_{L} and ϕp_{T} are equal and the angular magnification provided by the lateral anamorphic component 110 may be given as:

$${M}_{L} = {M}_{T} * {P}_{T} / {P}_{L} \qquad eqn . 7$$

The angular magnification M_{L}, M_{T} of the lateral and transverse anamorphic optical elements 110, 60 is proportional to the respective optical power K_{L}, K_{T} of said elements 60, 110. The first spatial light modulator 48A may comprise pixels 222 having pitches P_{L}, P_{T} in the lateral and transverse directions 195, 197 with a ratio P_{L}/P_{T} that is the same as K_{T}/K_{L}, being the inverse of the ratio of optical powers of the lateral and transverse anamorphic optical elements 110, 60.

In FIG. 8A, the sub-pixels 222AR, 222AG, 222AB are distributed in columns of red, green, and blue pixels. Advantageously vertical and horizontal image lines may be provided with high fidelity.

In the alternative embodiment of FIG. 8B, the sub-pixels 222AR, 222AG, 222AB are distributed along diagonal lines. Advantageously reproduction of natural imagery may be improved in comparison to the embodiment of FIG. 8A.

The sub-pixels 222AR, 222AG, 222AB may be provided by white light emission and patterned colour filters, or may be provided by direct emission of respective coloured light. The present embodiments comprise sub-pixel 222A pitch P_{L} that is larger than other known arrangements comprising a symmetric input lens for thin waveguides.

In the alternative embodiment of FIG. 8C, multiple blue pixels 222AB1 and 222AB2 may be provided. The blue pixels 222AB1, 222AB2 may be driven with reduced current for a desirable output luminance. Advantageously the lifetime of the pixels may be improved, for example when the first spatial light modulator 48A is provided by an OLED microdisplay. In other embodiments, additional or alternative white pixels (for example with no colour filters) or a fourth colour such as yellow may be provided. Alternatively, different colour emission spectral bands may be provided by the first and second spatial light modulators 48A, 48B and/or by the first and second illumination systems 102A, 102B. Colour gamut and/or brightness and efficiency may advantageously be achieved.

In the alternative embodiment of FIG. 8D, the footprint of the red sub-pixels 222AR is larger than that of the green and blue sub-pixels. In micro-LED displays, small red-emitting pixels may be provided by AlInGaP material system, compared to InGaN material system for green and blue emitters. Such red emitters have reabsorption losses that increase with shrinking pixel size. Advantageously the red micro-LED emitter size is increased and display efficiency is improved. Similarly for OLED pixels, it may be desirable to provide larger blue pixels than red or green pixels to increase display lifetime.

An illustrative arrangement of second pixels 222B of the spatially multiplexed spatial light modulator 48B will now be described.

FIG. 9A is a schematic diagram illustrating in front view an arrangement of non-anamorphic pixels 222B of a spatial light modulator 48B for use in the non-anamorphic illumination system 102B of FIG. 1 and comprising spatially multiplexed red, green and blue non-anamorphic sub-pixels 222BR, 222BG, 222BB; and FIG. 9B is a schematic diagram illustrating in front view an arrangement of non-anamorphic pixels 222B of a spatial light modulator 48B for use in the non-anamorphic illumination system of FIG. 1 and comprising a hexagonal sub-pixel arrangement. Features of the embodiments of FIGS. 9A-B not discussed in further detail may be assumed to correspond to the features with equivalent reference numerals as discussed above, including any potential variations in the features.

FIG. 9A illustrates that the pixels 222BR, 222BG, 222BB may be arranged so that the retinal image arrangement of sub-pixels is the same as that as provided from the pixels 222A. Advantageously improved image fidelity may be achieved for text or line images for example. The alternative sub-pixel arrangement of FIG. 9B illustrates a hexagonal pixel 222B arrangement that may provide improved image appearance for the reproduction of natural images, for example photographic images. The pixel arrangement comprising alternative arrangements of sub-pixels 222BR, 222BG, 222BB of the second illumination system 102B may be different to the pixel arrangement of sub-pixels 222AR, 222AG, 222AB of the first illumination system 102A. One of the first illumination system 102A and second illumination system 102B may be arranged to present text while the other of the first illumination system 102A and second illumination system 102B may be arranged to present natural images. Advantageously improved image fidelity may be achieved. The sub-pixel embodiments of the present disclosure are not limiting and other sub-pixel arrangements may be used for one or both of the spatial light modulators 48A, 48B.

The second spatial light modulator 48B may be a transmissive spatial light modulator such as a TFT-LCD further comprising a backlight. Alternatively the second spatial light modulator 48B may be a reflective spatial light modulator such Liquid Crystal on Silicon (LCOS) or a Microoptoelectromechanical (MOEMS) array of micro-mirrors such as the DMD from Texas Instruments. Alternatively the second spatial light modulator 48B may be an emissive spatial light modulator using material systems such as OLED or inorganic micro-LED. A silicon backplane may be provided to achieve high speed addressing of high resolution arrays of second pixels 222B.

In comparison to the embodiments of FIGS. 8A-C, the non-anamorphic optical system 50B has the same lateral and transverse magnifications M_{L}, M_{T} and the embodiment of FIG. 9A illustrates that the second pixels 222B may be arranged on a square grid in the case that white pixels with equal pitch in lateral and transverse directions 195 (46), 197 (46) are desirable at the retina 46 of the eye 45. Spatial light modulators 48B with such symmetric pixel 222B aspect ratios are widely available and may be provided at reduced cost.

The spatial light modulators 48A, 48B may comprise pixels 222A, 222B that are provided by different technologies to achieve enhanced performance of the near-eye display apparatus 100.

Organic LED (OLED) spatial light modulators 48 comprise organic thin film emissive pixels 222 capable of achieving high image resolution with pixels smaller than 3 micrometres, high image contrast, for example greater than 1000:1 and have thin package thickness, not using a separate illumination system such as a backlight or frontlight illumination. However OLED panels have a luminance that is limited by the material technology of the OLED materials with typical maximum brightness limited to 5,000 nits or less, and suffer from burn-in during prolonged operation in a single luminance state, undesirably providing image artefacts. The burn-in effect is caused by a reduction in the light output of the material at a given current as a result of the time spent emitting. This reduction rate is different for the respective RGB materials. To compensate for colour dependent burn-in, the brightness of the whole panel is reduced, undesirably reducing the retinal illuminance of image 31.

Micro-LED spatial light modulators 48 comprise inorganic emissive pixels 222 capable of achieving high image resolution with pixels smaller than 3 micrometres, high image contrast, for example greater than 1000:1, have thin package thickness and luminance that may be 50,000 nits or greater.

Liquid crystal display (LCD) spatial light modulators comprise an illumination system and switchable liquid crystal displays. Transmissive spatial light modulators may comprise pixels 222 that are larger than emissive pixels, for example larger than 20 micrometres and require an illumination system that increases the physical bulk of the spatial light modulator 48 arrangement. However, larger size transmissive spatial light modulators 48 may be fabricated at low cost. Reflective LCD spatial light modulators 48 may comprise smaller pixels arranged on a reflective backplane and an external illumination system that may be undesirably bulky. The reflective LCD may comprise pixel circuitry under or partially under the reflector. LCD technologies have limited contrast, for example less than 1000:1 and relatively slow response times. Increased brightness can be achieved by increasing the backlight or frontlight illuminance.

The pixels 222 of the respective spatial light modulators 48 may be driven with image data by means of a backplane and associated panel scanning circuitry. Transmissive LCD and OLED pixels may be driven by thin film transistors (TFT) on glass or polymer substrates. Advantageously large area spatial light modulators 48 may be fabricated at low cost, but small pixels (<10 micrometres size) may be complex to manufacture. Large area panels have a feature size limitation defined by the lithography design rules. For large area glass the minimum feature size is much larger than on a semiconductor wafer. The minimum feature size controls the minimum size that a pixel circuit transistor or TFT can be made.

Semiconductor backplanes may be provided to achieve small pixels and high pixel densities. Semiconductor backplanes may comprise materials such as silicon, gallium nitride and silicon carbide. OLED on silicon spatial light modulators 48 may be termed OLEDOS; LCD on silicon spatial light modulators 48 may be termed LCOS. By comparison, TFT backplane technologies on glass or polymer can provide larger panel sizes at low cost.

It has been appreciated that each pixel 222 technology has different desirable features. Embodiments of the present disclosure achieve desirable increase in performance of the near-eye display apparatus using spatial light modulators 48A, 48B that comprise different properties, with non-exhaustive illustrative embodiments wherein the first spatial light modulator 48A and second spatial light modulator 48B are different described in TABLE 3 for the example wherein the retinal images 31A, 31B are intended to have square aspect ratio with equal resolution in lateral and transverse directions 195, 197.

TABLE 3

| Illustrative embodiment | | (1) | (2) | (3) | (4) | (5) |
|---|---|---|---|---|---|---|
| First | Pixel 222A | OLED | OLED | MicroLED | MicroLED | MicroLED |
| spatial | material | | | | | |
| light | Pixel 222A | 5,000 | 5,000 | 50,000 | 50,000 | 50,000 |
| modulator | brightness | | | | | |
| 48A | (nits) | | | | | |
| | Backplane | Semiconductor wafer | | | | |
| | type | | | | | |
| | Lateral pixel | 40 | 40 | 16 | 16 | 16 |
| | pitch (μm) | | | | | |
| | Transverse | 8 | 8 | 4 | 4 | 4 |
| | pixel pitch | | | | | |
| | (μm) | | | | | |
| | Number of | 1000 × 1000 | 1000 × 1000 | 2000 × 2000 | 3000 × 3000 | 3000 × 3000 |
| | pixels | | | | | |
| Second | Pixel 222B | OLED | Transmissive | Transmissive | OLED | MicroLED |
| spatial | material | | LCD | LCD | | |
| light | Pixel 222B | 5,000 | 2,000 | 2,000 | 1,000 | 10,000 |
| modulator | brightness | | | | | |
| 48B | (nits) | | | | | |
| | Backplane | Semi- | TFT on | TFT on | TFT on | Semi- |
| | type | conductor | glass/ | glass/ | glass/ | conductor |
| | | wafer | polymer | polymer | polymer | wafer |
| | Lateral pixel | 8 | 25 | 25 | 15 | 8 |
| | 222B pitch | | | | | |
| | (μm) | | | | | |
| | Transverse | 8 | 25 | 25 | 15 | 8 |
| | pixel 222B | | | | | |
| | pitch (μm) | | | | | |
| | Number of | 4000 × 4000 | 2000 × 2000 | 2000 × 2000 | 6000 × 6000 | 4000 × 4000 |
| | pixels | | | | | |
| | (direction) | | | | | |

Illustrative embodiment (1) describes spatial light modulator 48A that comprises pixels 222A that are OLED on a silicon backplane that is 8×40 mm in size and spatial light modulator 48B that comprises pixels 222B that are OLED on a silicon backplane that is 32×32 mm in size. Advantageously the cost of the first spatial light modulator 48A, which has lower area of semiconductor backplane, is substantially lower than the cost of the second spatial light modulator 48B. Enhanced brightness may be achieved by the addition of the light from the two spatial light modulators 48A, 48B. The retinal images 31A, 31B may be provided with the same spatial resolution and with different fields of view, improving image definition, or may have different resolutions and similar or the same fields of view. Image data appearing in the same position to the observer's eye may also be swapped between the two spatial light modulators so that burn-in on each of the spatial light modulators is reduced. OLED displays are more prone to burn-in effect than the other display technologies. Advantageously the useful life of the device before the onset of significant burn-in degradation may be increased.

In an alternative embodiment, the two OLED displays used may comprise different OLED technologies. For example, one may use a white OLED material and colour filters to produce colour pixels. The other may use directly emitting RGB colour pixels. Typically, it is easier to achieve high brightness from directly emitting colour pixels. By selecting the individual OLED technologies appropriate to the images being displayed, for example the continuously-on image may use the lower power technology and the icon overlay may use a lower efficiency OLED. Power consumption may advantageously be reduced.

By way of comparison with illustrative embodiment (1), illustrative embodiment (2) comprises a second spatial light modulator 48B comprising a transmissive LCD with an active area of 50×50 mm and backlight such as a high luminance mini-LED backlight. Advantageously cost is reduced. However pixel 222B minimum pitch is limited by the need to maintain a reasonable transmissive LCD aperture ratio (ratio of transmissive area of pixel to total area of pixel including drive transistors). Low aperture ratio reduces display efficiency. A typical OLED drive circuit is more complex than that of an LCD and may require about 7 transistors per pixel. Integrating this number of transistors with a small pixel pitch becomes more difficult on glass substrates which have a higher minimum feature size than for semiconductor wafers.

By way of comparison with illustrative embodiment (2), illustrative embodiment (3) comprises a micro-LED display of size 8×32 mm that has a substantially higher brightness compared to OLED. Image 31B highlights with high retinal illuminance may be provided by image 31A for example.

By way of comparison with illustrative embodiment (1), illustrative embodiment (4) comprises a spatial light modulator 48A with micro-LED display of size 12×48 mm that has a substantially higher brightness compared to OLED. Image 31 highlights with high retinal illuminance may be provided by image 31A for example. The 90×90 mm OLED-on-TFT panel cannot achieve the same pixel density or brightness compared to OLED-on-silicon panel, may advantageously achieve lower cost and wide field of view (retinal image 31 size) for a given focal length of the optical system 50B. In addition, a micro-LED does not reduce in brightness with use, and does not suffer burn-in, as a typical OLED does. The micro-LED is therefore useful for providing high brightness icons, or icons that are largely static in the display. Advantageously the lifetime of the equipment before the onset of significant panel degradation is improved.

By way of comparison with illustrative embodiment (4), illustrative embodiment (5) comprises a spatial light modulator 48B with micro-LED display of size 32×32 mm that has a substantially higher brightness compared to an OLED-on-Si panel of embodiment (1). High image brightness may be achieved to advantageously improve image realism. In addition, the micro-LED displays have little degradation of brightness with illumination use time and do not suffer image burn-in effects. Advantageously the operating lifetime hours of the device is improved.

Arrangements of spatial light modulators 48A, 48B and corresponding images 30A, 30B will now be described further.

FIG. 10A is a schematic diagram illustrating in front view a first spatial light modulator 48A for use in the anamorphic illumination system 102A of FIG. 1; and FIG. 10B is a schematic diagram illustrating in front view a second spatial light modulator 48B for use in the non-anamorphic illumination system 102B and with the spatial light modulator 48A of FIG. 10A; FIG. 10C is a schematic diagram illustrating in front view the retinal image 31A from the anamorphic illumination system 102A provided by the spatial light modulator 48A of FIG. 1 and FIG. 10A; and FIG. 10D is a schematic diagram illustrating in front view an intended retinal image 31B for use in the non-anamorphic illumination system 102B of FIG. 1 and with the spatial light modulator 48B of FIG. 10B. Features of the embodiment of FIGS. 10A-D not discussed in further detail may be assumed to correspond to the features with equivalent reference numerals as discussed above, including any potential variations in the features.

The spatial light modulators 48A, 48B are provided with perimeters that achieve octagonal shapes of retinal images 31A, 31B respectively. Other shapes such as rectangular and circular may alternatively be provided for the retinal images 31A, 31B and corresponding spatial light modulators 48A, 48B outer shapes.

An aspect ratio of the first pixels 222A is different to an aspect ratio of the second pixels 222B. FIG. 10C illustrates that the pixels 222A of the anamorphic spatial light modulator 48A are imaged anamorphically to the image 31A with a square pixel image 223A. In the present embodiment, the pixel image 223 represents the imaging of the angular pixel data from the near-eye display apparatus 100 by the eye 45 onto the retina 46. More generally, a pixel 222 is output by the optical apparatus 50 to provide output angular data, with a pixel 222 being imaged to a ray bundle. The ray bundle is imaged by an optical system 50 to provide the pixel image 223. For display 100 measurement purposes, the eye 45 lens may be replaced by a camera lens and the retina 46 may be a sensor such as a CCD for example.

By comparison, FIG. 10D illustrates that the non-anamorphic spatial light modulator 48B is imaged non-anamorphically to the image 31B that also has square image pixels 223A. Second spatial light modulator 48B could alternatively have rectangular (or other shaped) pixels 222B that are non-anamorphically imaged to the pixels 223B that have the same rectangular (or other shape) with the same aspect ratio. Advantageously alternative arrangements of image 31 resolution may be achieved.

In practice, aberrations such as distortion aberrations provide output pixels 223A, 223B that are not imaged without variations in location and shape. Such aberrations may be compensated by correction of image data provided to the respective pixels 222A, 222B, or by adjustment of the location of pixels 222A, 222B on the respective spatial light modulators 48A, 48B. However to simplify the description, such aberrations are not illustrated in FIGS. 10C-D.

The retinal images 31A, 31B may have different properties associated with the arrangements of spatial light modulators 48A, 48B and optical systems 50A, 50B.

To provide large eyeboxes 40B, the second spatial light modulator 48B is desirably provided with an image diagonal greater than 25 mm for example. To achieve low cost for such larger spatial light modulators 48, preferable display technologies include but are not limited to OLED or backlit LCD technologies.

In an alternative embodiment the spatial light modulators 48A, 48B may provide different wavelength ranges of light. For example, each spatial light modulator may have a different colour gamut so that the resulting image received by the eye can be provided with a colour gamut that is increased over that provided by a single spatial light modulator. For example, the two gamuts may cooperate to extend the triangular shaped gamut from 3 primaries to a quadrilateral, pentagonal or hexagonal shaped gamut.

In a further illustrative embodiment, an LCD may be illuminated by a narrow band LED backlight advantageously with high efficiency. Alternatively, an OLED spatial light modulator 48A, or spatial light modulator 48B may use an OLED material with good lifetime and efficiency as opposed to RGB OLED materials, advantageously achieving reduced power consumed or reduced pixel burn-in.

Inorganic micro-LED technologies are capable of very high luminance, for example greater than 20,000 nits, can have pixels of pitch less than 10 micrometres, and provide high image contrast and fast response times. However efficiency of micro-LEDs falls at the smallest scales, for example less than 5 micrometres emitter size.

The first spatial light modulator 48A may be provided by a different display technology to the second spatial light modulator 48B so that the near-eye display apparatus 100 may be provided with performance that is improved in comparison to the use of a single display technology for both spatial light modulators 48A, 48B.

In an illustrative example, the first spatial light modulator 48A may be provided by inorganic micro-LED pixels and the second spatial light modulator 48B may be provided by OLED pixels. Considering FIG. 10C, the retinal image 31A is provided with high brightness and the image 31B is provided with high resolution. The first image 30A provided by the first spatial light modulator 48A and first optical apparatus 50A has an angular resolution that is different to an angular resolution of the second image 30B provided by the second spatial light modulator 48B and second optical apparatus 50B.

A very high brightness image 31 and high resolution image may be provided. Such a combined image 31 may be provided with high dynamic range (HDR, with high contrast and high luminance) and high resolution. Controllers 500, 500A, 500B may be arranged to provide image data corresponding to HDR images onto the two spatial light modulators 48A, 48B. Image realism may advantageously be increased.

In a further illustrative example, the first spatial light modulator 48A may be provided by OLED pixels and the second spatial light modulator 48B may be provided by TFT-LCD pixels. The image 31A is provided with high resolution and the image 31B is provided with high efficiency and low cost.

In a further illustrative example, the first and second spatial light modulators 48A, 48B may be provided by different types of OLED pixels. The spatial light modulator 48A may be provided by OLED pixels 222A on a silicon backplane (OLEDOS) and the spatial light modulator 48B may be provided by OLED pixels 222B on a TFT backplane. The spatial light modulator 48B may provide images 31B with high image resolution, while the spatial light modulator 48A may provide images with increased response speed. Advantageously the parts of the image that require fast response may be adjusted on the faster spatial light modulator 48A to reduce image lag.

Other illustrative embodiments for retinal images 31A, 31B that may be provided by the spatial light modulators 48A, 48B and optical apparatuses 50A, 50B will now be described.

FIG. 10E is a schematic diagram illustrating in front view an alternative intended retinal image 31A provided by the anamorphic illumination system 102A of FIG. 1; FIG. 10F is a schematic diagram illustrating in front view an alternative intended retinal image 31B provided by the non-anamorphic illumination system 102B of FIG. 1 and overlaid with the intended retinal image 31A of FIG. 10E;

FIG. 10G is a schematic diagram illustrating in front view an alternative intended retinal image 31A from the anamorphic illumination system 102A of FIG. 1; and FIG. 10H is a schematic diagram illustrating in front view an alternative intended retinal image 31B from the non-anamorphic illumination system 102B of FIG. 1. Features of the embodiment of FIGS. 10E-H not discussed in further detail may be assumed to correspond to the features with equivalent reference numerals as discussed above, including any potential variations in the features.

By way of comparison with FIGS. 10A-B, FIG. 10F illustrates that the retinal images 31A, 31B may be provided with different fields of view. Image resolution in a central area of interest, for example areas that provide text information may be increased, while a wide field of view may be provided by the larger retinal image 31B in the transverse direction. The retinal image 31B may be dimmed in the area of the retinal image 31A by means of control of data on the spatial light modulator 48B for example.

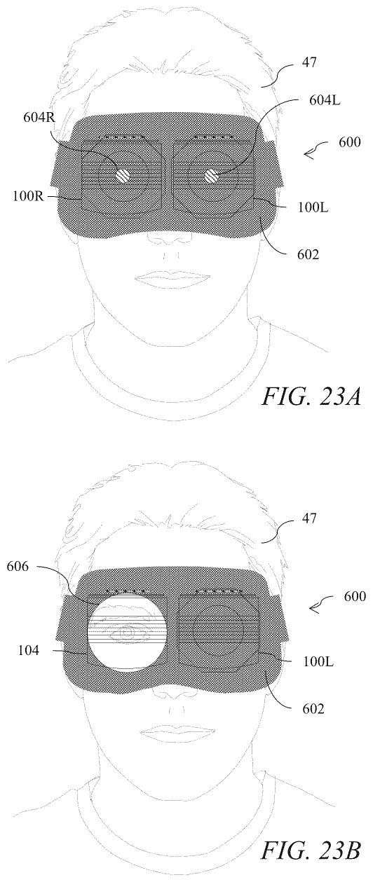

The alternative embodiments of FIGS. 10G-H illustrate that the images 31A, 31B may be provided with different content. FIG. 10G illustrates the retinal image 31A with pixel image 223A to be overlayed onto the retinal image 31B comprising pixel image 223B of FIG. 10H. In the region 225 no image data may be presented on the spatial light modulator 48B, so as to provide removal of the original background data in the region of the retinal pixel image 223A. The pixel image 223B may comprise for example a pass-through image of a real-world scene captured for example by cameras 604 as illustrated on the head-mounted display apparatus 600 of FIG. 23A hereinbelow. Advantageously real-world scenes may be presented with synthetic images with desirable obscuration.

FIG. 10I is a schematic diagram illustrating in front view alternative intended left-eye retinal images 31AL, 31BL and right-eye retinal images 31AR, 31BR from a head-worn display apparatus 600 such as that illustrated in FIG. 23A hereinbelow. Features of the embodiment of FIG. 10I not discussed in further detail may be assumed to correspond to the features with equivalent reference numerals as discussed above, including any potential variations in the features.

By way of comparison with the embodiment of FIG. 10F, the alternative embodiment of FIG. 10I comprises retinal images 31AL, 31AR and 31BL, 31BR and thus respective fields of view that are offset and provide non-overlapping retinal image regions 631L, 631R, and overlapping retinal image regions 633L, 633R.

The regions 633L, 633R may be arranged within the binocular field of the human visual system, and in the region of the images 31BR, 31BB, a stereoscopic image is perceived. By comparison, the regions 631L, 631R may for example be arranged in locations that are outside the binocular field so that only one eye sees the respective regions 631L 631R. In operation, the visual system peripheral response may be improved, advantageously improving display realism and user safety.

The spatial light modulators 48AL, 48AR may be provided with monochrome images, advantageously reducing cost and complexity. In other embodiments, the retinal images 31AL, 31AR may not overlap the respective retinal images 31BL, 31BR to achieve even wider field of view.

The near-eye display apparatus 100 may comprise different depth planes for presentation of image data.

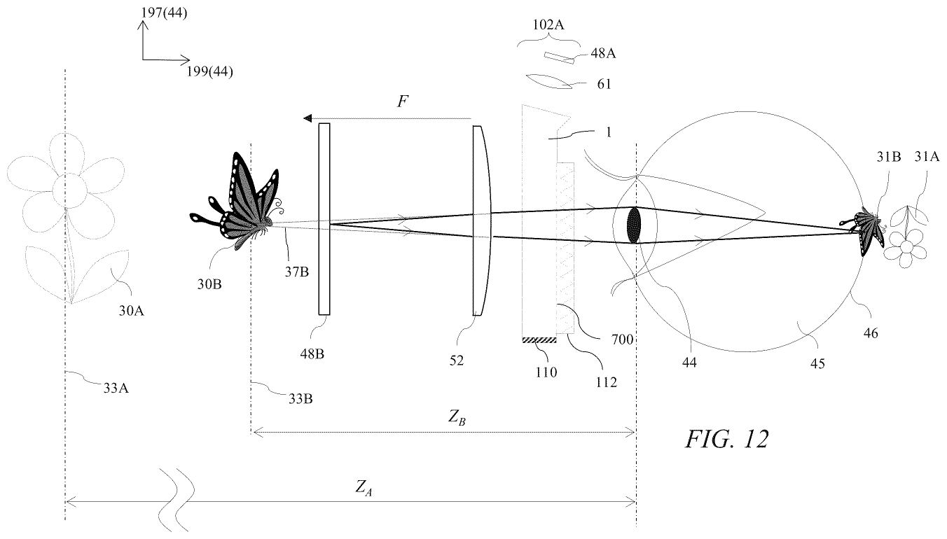

FIG. 11 is a schematic diagram illustrating a side view of retinal image formation for the anamorphic illumination system 102A of FIG. 1; and FIG. 12 is a schematic diagram illustrating a side view of retinal image formation for the non-anamorphic illumination system 102B of FIG. 1 wherein the virtual image is arranged at a finite distance from the eye. Features of the embodiments of FIGS. 11-12 not discussed in further detail may be assumed to correspond to the features with equivalent reference numerals as discussed above, including any potential variations in the features.

FIG. 11 illustrates that the virtual image 30A from the first illumination system 102A is provided substantially at an infinite conjugate distance Z_{A}. The lens of the eye 45 is adjusted to provide the retinal image for the said infinite conjugate.

By comparison, FIG. 12 illustrates that the virtual image distance Z_{A} provided by the first optical apparatus 50A is different to a virtual image distance Z_{B} provided by the second optical apparatus 50B. Virtual image 30B from the second illumination system 102B is provided with optical apparatus 50B with focal length F and spatial light modulator 48B arranged to provide a finite conjugate distance Z_{B}. To observe the virtual image 30B, the lens of the eye 44 adjusts focus so that the retinal image 31B is in focus on the retina 46. In an illustrative embodiment, the offset may be 0.5 Dioptres, that is the virtual image distance Z_{B} is approximately 2m.

The embodiment of FIG. 12 may be provided with the obscuration image 225 of FIG. 10H for example, so that the image 30B is a foreground image and the image 30A is a background image for which the eye refocuses in order to observe respective image in focus.

It may be desirable to provide further adjustment of virtual image distances Z_{A}, Z_{B}.

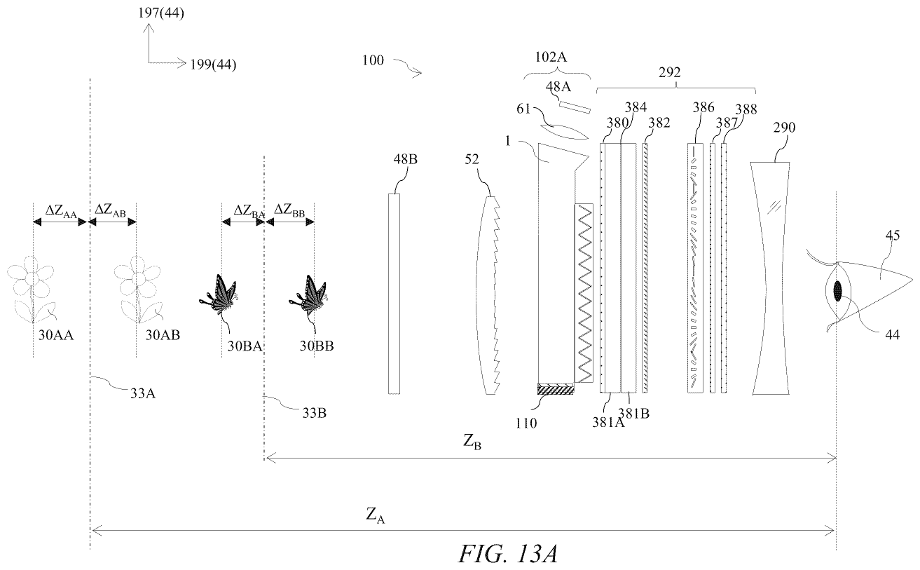

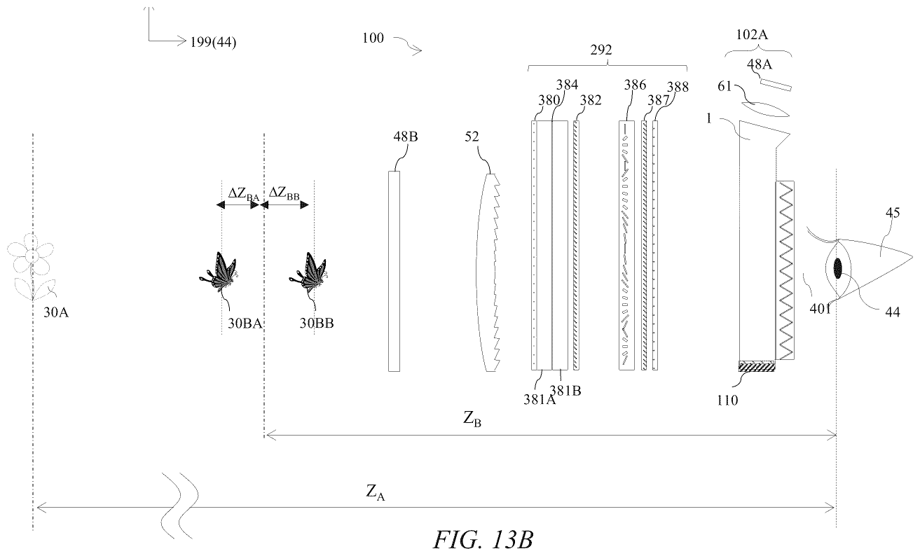

FIG. 13A is a schematic diagram illustrating in side view an alternative near-eye display apparatus 100 further comprising Pancharatnam-Berry lenses arranged to provide adjustable focal distances for virtual images from the anamorphic illumination system 102A and non-anamorphic illumination system 102B; and FIG. 13B is a schematic diagram illustrating in side view an alternative near-eye display apparatus 100 further comprising Pancharatnam-Berry lenses arranged to provide adjustable focal distances for virtual images from non-anamorphic illumination system 102B. Features of the embodiments of FIGS. 13A-B not discussed in further detail may be assumed to correspond to the features with equivalent reference numerals as discussed above, including any potential variations in the features.

It may be desirable to provide modification of the distances Z_{A} to the virtual image planes 33A, 33B of the virtual images 30A, 30B provided by the first and second illumination systems 102A, 102B.

In the alternative embodiment of FIG. 13A, the near-eye display apparatus 100 further comprises at least one lens 290 that may be a corrective lens having optical power for correcting eyesight. The correction of eyesight may be for example to correct for presbyopia, astigmatism, myopia or hyperopia of the display user 45.

The lens 290 may further or alternatively be a focal plane modifying lens for providing the virtual image 33 such that the distance Z is a finite distance. Such an arrangement may provide suitable accommodation cues for the display user 47 such that virtual images that are desirably close to the user 47 are provided at desirable accommodation distances. In stereoscopic display applications, the accommodation correction of the lens 290 may be arranged to approximate the convergence distance of the imagery. Accommodation-convergence mismatch may be reduced and advantageously visual stress reduced, increasing comfort of use.

The alternative embodiment of FIG. 13A also comprises a switchable optical stack 292 that comprises a Pancharatnam-Berry lens 386. In alternative embodiments, the switchable optical stack 292 of FIG. 13A may be omitted, advantageously achieving reduced cost and complexity.

It may be desirable to dynamically adjust the accommodation distance Z of the virtual image.

Switchable optical stack 292 comprises input polariser 380, transparent substrates 381A, 381B with an electrically switchable liquid crystal layer 384 provided therebetween and a quarter-wave retarder 382. In a first state, the liquid crystal layer 384 is arranged to provide no polarisation rotation of the polarised light from the polariser 380 and the switchable optical stack 292 provides a first circularly polarised output polarisation state 383A. In a second state, the liquid crystal layer 384 is arranged to provide a polarisation rotation of the polarised light from the polariser 380 and the switchable optical stack 292 provides a second circularly polarised output polarisation state 383B, orthogonal to the polarisation state 383A.

The Pancharatnam-Berry lens 386 comprises a circularly symmetric alignment of liquid crystal molecules with a radial phase profile similar to profile. The output polarisation state from the Pancharatnam-Berry lens 386 is analysed by quarter-wave retarder 387 and linear polariser 388. Further description of Pancharatnam-Berry lens 386 is described in further detail in U.S. patent application Ser. No. 18/734,222 filed Jun. 5, 2024 (Atty. Ref. No. 502001), which is herein incorporated by reference in its entirety.

Output light from the lens 290A with positive or negative power modification of the wavefront from the anamorphic first illumination system 102A is then incident onto the fixed lens 290B so that the eye 45 observes one of the two power corrections.

Considering the virtual images 30A, 30B, and in the absence of the lens 290A would provide virtual image at distance Z_{A}, Z_{B}. In the first state of the liquid crystal layer 384, the virtual images 30AA, 30BA are provided with separation ΔZ_{A}, ΔZ_{B} from the distances Z_{A}, Z_{B} respectively; and in the second state of the liquid crystal layer 384, the virtual images 30AB, 30BB are provided.

In alternative embodiments, the lens 290 may be provided by a further Pancharatnam-Berry lens. Advantageously thickness may be reduced.

The lenses 290, 292 thus achieve adjustable accommodation distances for virtual images 30A, 30B. Stacks of lenses 290A with for example a geometric sequence of optical power adjustments may be provided to achieve increased fidelity in location of the virtual image 334. Accommodation conflicts with the provided imagery may advantageously be reduced and image comfort increased. Comfortable usage time for the head-worn display apparatus 600 may be extended.

By way of comparison with FIG. 13A, the alternative embodiment of FIG. 13B illustrates that the output of the second illumination system 102B is modified by the switchable optical stack 292 that comprises a Pancharatnam-Berry lens 386. The background virtual image 30A may be provided with an infinite conjugate distance to represent background information such as pass-through image data, while the foreground information may be provided with appropriate viewing distance.

Most generally, the content of the image 31B may be similar to the image 31A, or may have at least one difference including but not limited to: (i) different image resolution; (ii) different retinal illuminance; (iii) different modulation transfer function; (iv) different contrast; (v) different field of view; (vi) may be arranged in at least one focal plane that is different to the at least one focal plane; and (vii) different response speeds; (ix) different pixel arrangements; and (ix) different colour gamuts as will be described further hereinbelow.

Further arrangements of spatial light modulator 48A comprising laser sources will now be described.

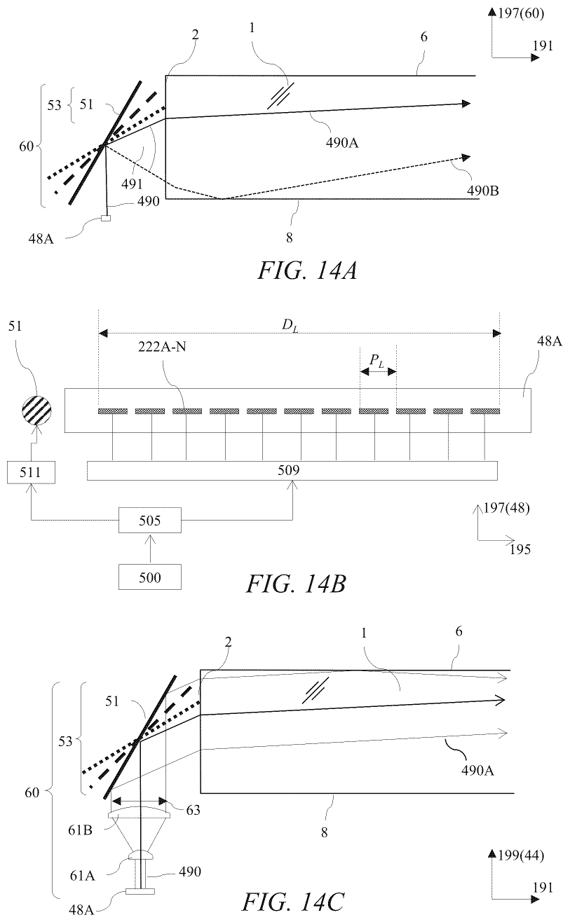

FIG. 14A is a schematic diagram illustrating in side view input to the extraction waveguide 1 comprising a spatial light modulator 48A comprising laser sources and a deflector element 53; FIG. 14B is a schematic diagram illustrating in front view a spatial light modulator 48A comprising a row of laser light sources 222A-N for use in the arrangement of FIG. 14A; and FIG. 14C is a schematic diagram illustrating an alternative illumination arrangement. Features of the embodiment of FIGS. 14A-C not discussed in further detail may be assumed to correspond to the features with equivalent reference numerals as discussed above, including any potential variations in the features.

The alternative embodiment of FIG. 14A comprises a transverse anamorphic component 60 that is formed by a deflector element 53 that comprises scanning mirror 51.

FIG. 14B illustrates a spatial light modulator 48A suitable for use in the arrangement of FIG. 14A comprising a one dimensional array of pixels 222A-N wherein the pixels 222A-N each comprise a laser source. Control apparatus 500 is arranged to supply line-at-a-time image data to spatial light modulator 48A controller 505 that outputs pixels data to laser pixels 222A-N by means of driver 509; and location data to deflector element 53 by means of scanner driver 511. The laser pixels 222A-N are arranged in a single row with pitch P_{L} in the lateral direction 195 that is the same as illustrated in FIG. 2D for example.

Returning to the description of FIG. 14A, in operation, image data for a first addressed row of image data are applied to the laser pixels 222A-N and the deflector element 53 adjusted so that the laser light from the spatial light modulator 48A is directed as ray 490A in a first direction across the transverse direction 197. At a different time, image data for a different addressed row of image data are applied to the laser pixels 222A-N and the deflector element 53 adjusted so that the laser light from the spatial light modulator 48A is directed as ray 490B in a different direction across the transverse direction 197. The transverse anamorphic component 60 is thus arranged to receive light from the spatial light modulator 48A and the illumination system 240 is arranged so that light output from the transverse anamorphic component 60 is directed in directions illustrated by rays 490A, 490B that are distributed in the transverse direction 197 with cone 491.

In other words, the deflector element 53 scans about the lateral direction 197 (60) and serves to provide illustrative light rays 490A, 490B sequentially. By means of sequential scanning, the deflector element 53 effectively has positive optical power in the transverse direction 197 (60) for light from the spatial light modulator 48A, achieving output cone 491 in a sequential manner. In this manner, the deflector element 53 directs light in directions that are distributed in the transverse direction, allowing it to serve as a transverse anamorphic component 60. The scanning of the deflector element 53 may be arranged to not direct light near to parallel to the direction 191 along the extraction waveguide 1. Advantageously double imaging is reduced.

Advantageously the cost and complexity of the illumination system 240 and transverse anamorphic component 60 may be reduced.

The alternative embodiment of FIG. 14C provides beam expander 61A, 61B that increases the width 63 of the output beam from the illumination system 240. In FIG. 14C, the illumination system 240 further comprises a deflector element 53 arranged to deflect light output from the transverse anamorphic component 60 by a selectable amount, the deflector element 53 being selectively operable to direct the light output from the transverse anamorphic component 60 in the directions that are distributed in the transverse direction 197. Advantageously uniformity of the output image from across the exit pupil 40 is provided.

FIG. 15A is a schematic diagram illustrating a rear perspective view of an alternative deflection arrangement 112 of the anamorphic first illumination system 102A of FIG. 2A. Features of the embodiment of FIG. 15A not discussed in further detail may be assumed to correspond to the features with equivalent reference numerals as discussed above, including any potential variations in the features.

By way of comparison with FIG. 2A, in the alternative embodiment of FIG. 15A, the deflection arrangement 112 comprises a deflection element 116 comprising an array of deflection features 119A-E that, considering FIG. 5B, are arranged between the rear and front sides of the deflection arrangement member 113, wherein the rear side of the deflection arrangement is next to the retarder 73 and the front side is the front guide surface 8. The deflection features 119A-E may comprise dichroic stacks, reflective linear polarisers or liquid crystal layers as described elsewhere herein. By way of comparison with the operation of FIG. 5B, the draft facets 118B are omitted. Higher efficiency of operation and reduced stray light may advantageously be achieved and stray light and double imaging reduced.

FIG. 15B is a schematic diagram illustrating a rear perspective view of an alternative arrangement of the anamorphic illumination system 102A. Features of the embodiment of FIG. 15B not discussed in further detail may be assumed to correspond to the features with equivalent reference numerals as discussed above, including any potential variations in the features.

In comparison to the arrangement of FIG. 2A, in the alternative embodiment of FIG. 15B, the illumination system 240 is arranged on the side of the extraction waveguide 1 and the direction 191 in which the extraction waveguide 1 extends in the horizontal direction for the eyes 45 of the user. Thus the lateral direction 195 for the pupil 44 is vertical and the transverse direction 197 is horizontal. The near-eye display apparatus 100 may have reduced bulk of the sides of the head-worn display apparatus 600 as illustrated in FIG. 23A hereinbelow. Advantageously the aesthetic appearance of the head-worn display apparatus may be improved.

It may be desirable to provide a finite focal distance for the virtual image 30 of FIG. 1.

FIG. 15C is a schematic diagram illustrating a rear perspective view of an alternative extraction arrangement of the anamorphic first illumination system 102A of FIG. 15A; and FIG. 15D is a schematic diagram illustrating a rear perspective view of an alternative extraction arrangement of the anamorphic first illumination system of FIG. 15B. Features of the embodiments of FIGS. 15C-D not discussed in further detail may be assumed to correspond to the features with equivalent reference numerals as discussed above, including any potential variations in the features.

By way of comparison with FIG. 15A, in the alternative embodiment of FIG. 15C, each of the deflection features 119A-E is curved, and by way of comparison with FIG. 15B, in the alternative embodiment of FIG. 15D each of the light deflection features 118A-D is curved.

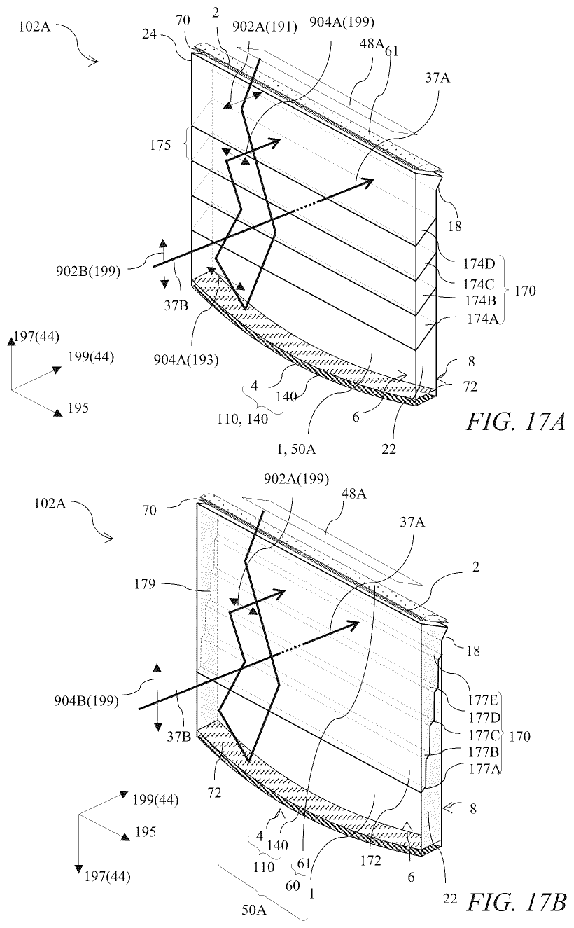

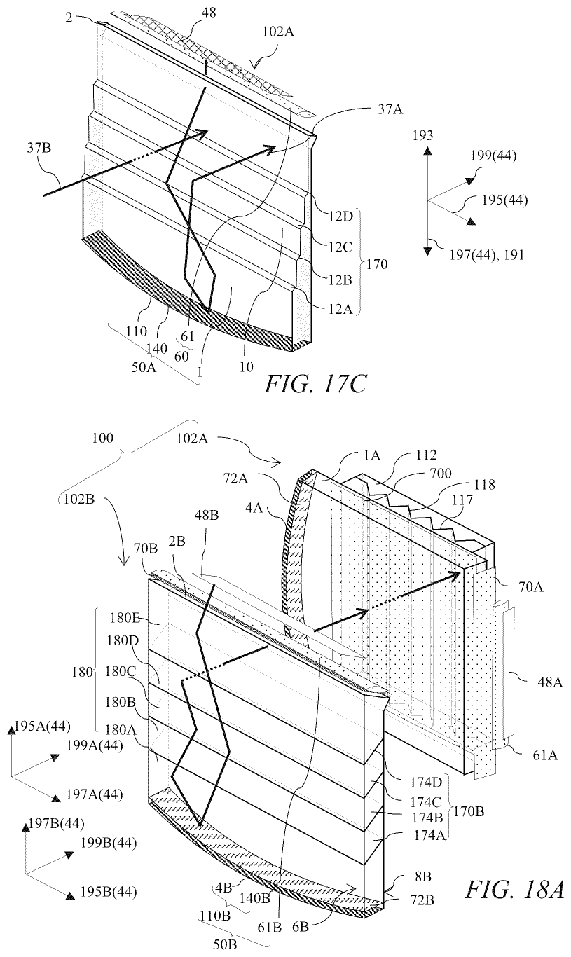

Alternative arrangements of curved light extraction features may comprise but are not limited to features 172 of FIGS. 16A-B, features 174 of FIGS. 17A-B, facets 12A-D of FIG. 17C herein. Such curved light extraction features may achieve finite viewing distance ZV distance for virtual image 30 as will be described further in the illustrative example of FIGS. 15E-F.

FIG. 15E is a schematic diagram illustrating a front view of the operation of the anamorphic first illumination system 102A of FIG. 15C in a near-eye display apparatus 100; and FIG. 15F is a schematic diagram illustrating a side view of the operation of the anamorphic first illumination system 102A of FIG. 15C in a near-eye display apparatus 100. Features of the embodiment of FIGS. 15E-F not discussed in further detail may be assumed to correspond to the features with equivalent reference numerals as discussed above, including any potential variations in the features.

Returning to the description of FIG. 1 and FIG. 2A, the light deflection features 118 are linear such that for a given virtual mage pixel 36A, the output light rays 460 are parallel to each other for locations across the front light guiding surface 8. Such parallel light rays are imaged by a normally corrected eye 45 to a common point in the retinal image 31 when the eye is arranged to focus for objects at infinity. The virtual image 30 of FIG. 1 is shown for illustrative purposes as being close to the near-eye display apparatus 100; in reality the eye 45 focusses in the same manner as it would for objects at infinity, that is in the far field.

It would be desirable to provide the virtual image 30 for non-infinite image distances ZV.

FIG. 15E illustrates that the curvature of the deflection features 119A-E and/or adjustment of the radius of curvature of the rear reflector 140 provide a variation in output directions 460 (195) A-E across the output area of the waveguide 1 in the lateral direction 195. Such variations across the lateral direction provide a cone 38 (195) in the lateral direction 195. To provide a sharp focus of the image point 35 (195) of pixel 222, the human visual system causes the eye 45 adjusts its focal length, and the eye 45 accommodates on the virtual image point 32A (195) that has a finite distance ZV₁₉₅A.

FIG. 15F illustrates that the curvature of the deflection features 119A-E and/or adjustment of the radius of curvature of the rear reflector 140 provide a variation in output directions 460 (197) A-E across the output area of the waveguide 1 in the transverse direction 197. Such variations across the transverse direction provide a cone 38 (197) in the transverse direction 197. To provide a sharp focus of the image point 35 (197) of pixel 222, the human visual system causes the eye 45 adjusts its focal length, and the eye 45 accommodates on the virtual image point 32A (197) that has a finite distance ZV₁₉₇A.

The distances ZV₁₉₅A and ZV₁₉₇A may be the same for an observer with low astigmatism or may be different to compensate for astigmatism of the eye 45.

FIG. 15F further illustrates that the second illumination system 102B provides imaging of the virtual image point 32A (197) to location 32A′ (197). The optical power of the non-anamorphic optical system 50B may provide further virtual image point 32A′ (197) that may be in a different plane 41B to the plane 41A of the virtual image point 32A′ (195), or may be in the same plane, as discussed elsewhere herein.

Thus a near-eye display apparatus 100 may provide images to an observer so that their eye 45 focusses at a finite viewing distance ZV.

Stereoscopic images may be provided for virtual images provided with image disparity suitable for finite viewing distance. Accommodation may be matched to image convergence and increased viewing comfort achieved. Correction for ophthalmic conditions such as myopia, hypertropia and presbyopia may be achieved for viewing of virtual images. Image blur may be reduced and image fidelity improved. In the transverse direction, each extraction feature may be curved with the same curvature. Cost and complexity of manufacture may be reduced.

By way of alternative in at least one of the transverse and lateral directions 195, 197, each extraction feature may be linear. The cost and complexity of fabrication of the array of extraction features may be reduced.

Each extraction feature 119 may be curved. Image blur may be reduced and image fidelity improved. In the transverse direction, each extraction feature may be curved with the same curvature. Cost and complexity of manufacture may be reduced. Each extraction feature 119 may be curved with a curvature that changes along the extraction waveguide in the second direction 193. Uniformity of the virtual image 30 may be improved and image blur reduced.

The vergences 38 (195), 38 (197) in at least one of the lateral and transverse directions 195, 197 may be divergence. The virtual image 30 may be arranged behind the near-eye display apparatus 100 and arranged to be around a typical viewing distance from the viewer 45, such as 250 mm. Well-corrected eyes and myopic eyes may be conveniently provided with sharp virtual images.

The lateral anamorphic component 110 and the extraction features 119 may be configured such that the output light from each point of the spatial light modulator 48 has vergence 38 (195) in the lateral direction 195 so that, when the output light is viewed by the eye 45 of the viewer, the vergence 38 (195) of the output light allows the eye 45 of the viewer to focus the output light from a finite viewing distance ZV in the lateral direction 195. The vergence 38 in the lateral direction may be divergence. The extraction features may be curved with negative optical power in the lateral direction 195 to cause divergence in the lateral direction 195. The vergence 38 (195) in the lateral direction 195 may be arranged to match the vergence 38 (197) in the transverse direction 197 and a sharp image 35 may be provided on the retina 46 of a well-corrected eye 45. The vergence 38 (195) in the lateral direction 195 may be arranged to be different to the vergence 38 (197) in the transverse direction 197. Correction for astigmatism of the eye 45 may be provided and increased image sharpness may be achieved.

The lateral anamorphic component 110 may be configured to cause divergence 38 (195) in the lateral direction 195. The extraction features 119 may alternatively be linear in the lateral direction to cause no change of the vergence 38 (195) of the output light in the lateral direction. The cost and complexity of the extraction features may be reduced.

The extraction features 119 may alternatively be curved with positive optical power in the lateral direction 195 to reduce the divergence caused by the lateral anamorphic component in the lateral direction. Each extraction feature may be curved in the lateral direction 195 with a curvature that changes along the extraction waveguide in the second direction. Aberrations may be reduced and increased fidelity of the perceived virtual image achieved across the exit pupil.

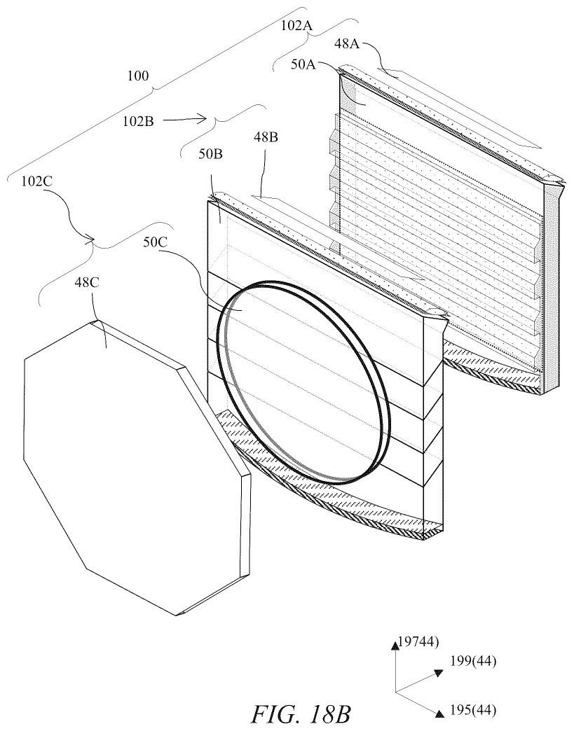

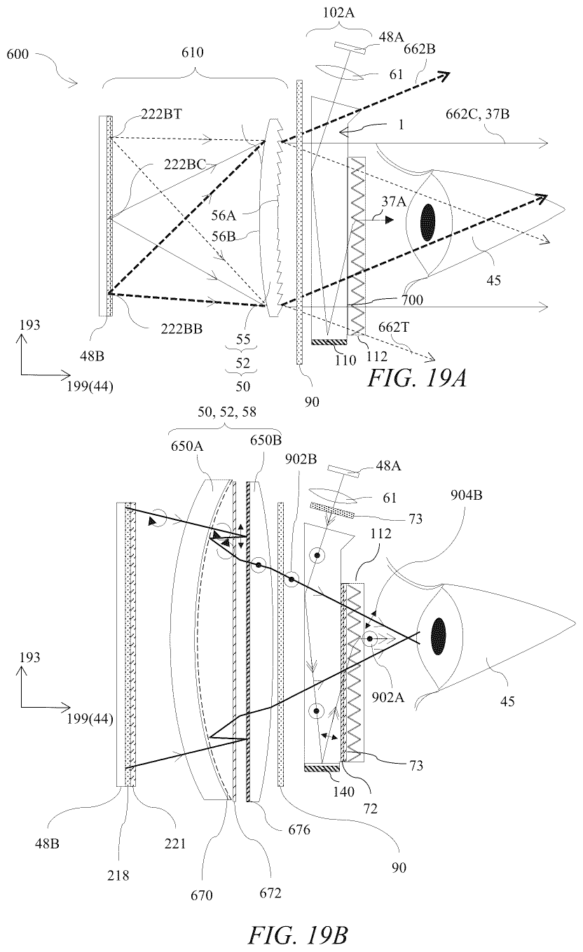

Further descriptions and alternatives of the embodiment of FIG. 7F to achieve finite viewing distance for a first illumination system 102A are described in U.S. Provisional Patent Appl. No. TBD titled “Anamorphic near-eye display apparatus” filed Nov. 14, 2024 (Atty. Ref. No. 505000A), which is herein incorporated by reference in its entirety. Curved light extraction features may be provided in the embodiments described herein to achieve said desirable viewing distances for virtual image 30, included but not limited to FIG. 1, FIGS. 16A-B, FIGS. 17A-C, FIGS. 18A-C and FIGS. 19A-B.

Alternative arrangements of anamorphic first optical apparatus 50A will now be described.

FIG. 16A is a schematic diagram illustrating a rear perspective view of an alternative anamorphic illumination system 102A wherein the polarisation-sensitive reflector 700 and extraction features 170 are arranged on the rear guiding surface 6 of the extraction waveguide 1; and FIG. 16B is a schematic diagram illustrating a side view of the anamorphic illumination system 102A of FIG. 16A. Features of the embodiment of FIGS. 16A-B not discussed in further detail may be assumed to correspond to the features with equivalent reference numerals as discussed above, including any potential variations in the features.

By way of comparison with FIG. 2A, in the alternative embodiment of FIGS. 16A-B, the extraction waveguide 1 comprises: a front guide surface 8; a polarisation-sensitive reflector 700 opposing the front guide surface 8; and an extraction element disposed outside the polarisation-sensitive reflector 700, the extraction element comprising: a rear guide surface 6 opposing the front guide surface 8; and an array of extraction features 170; the first illumination system 102A is arranged to provide light guided along the extraction waveguide 1 in the first direction 191 with an input linear polarisation state 902A before reaching the polarisation-sensitive reflector 700.

The first optical apparatus 50A further comprises a polarisation conversion retarder 72 disposed between the polarisation-sensitive reflector 700 and the light reversing reflector 140, wherein the polarisation conversion retarder 72 is arranged to convert a polarisation state of light passing therethrough between a linear polarisation state and a circular polarisation state, and the polarisation conversion retarder 72 and the light reversing reflector 140 are arranged in combination to rotate the input linear polarisation state 902A of the light guided in the first direction 191 so that the light guided in the second direction 193 and output from the polarisation conversion retarder 72 has an orthogonal linear polarisation state 904A that is orthogonal to the input linear polarisation state 902A.

The polarisation-sensitive reflector 700 is arranged to reflect light guided in the first direction 191 having the input linear polarisation state 902A and to extract light guided in the second direction 193 having the orthogonal linear polarisation state 904A, so that the front guide surface 8 and the polarisation-sensitive reflector 700 are arranged to guide light in the first direction 191, and the front guide surface 8 and the rear guide surface 6 are arranged to guide light in the second direction 193.

The array of extraction features 170 is arranged to extract light guided along the extraction waveguide 1 in the second direction 193 towards an eye of a viewer through the front guide surface 8, the array of extraction features 170 being distributed along the extraction waveguide 1 so as to provide exit pupil expansion in the transverse direction 197.

Extraction element 270 is disposed outside the polarisation-sensitive reflector 700, the extraction element 270 comprising: the rear guide surface 6 opposing the front guide surface 8; and an array of extraction features 170.

The array of extraction features 170 is arranged on the rear guide surface 6 that comprises plural prisms 171 that protrude outwardly. The prisms 171 each comprise at least one extraction facet 172, and at least one draft facet 174. At least one primary guide facet 176 may be arranged between the respective at least one extraction facet 172 and the at least one draft facet 174. The rear guide surface 6 further comprises guide portions 178 between the prisms 171.

The array of extraction features 170 comprises extraction facets 172A-D, each extraction facet 172 being arranged to reflect light 401, 402 guided in the second direction 193 towards the eye 45 of the viewer 47 through the front guide surface 8.

The array of extraction facets 172A-D are distributed along the extraction waveguide 1 so as to provide exit pupil 40 expansion in the transverse direction 197, in a similar manner to that described with reference to FIGS. 6A-B hereinabove for example.

The operation of the embodiment of illumination system 102A of FIG. 16A is similar to that of FIG. 2A and light from the second illumination system 102B with polarisation state 902B is transmitted through the waveguide 1 while image data from spatial light modulator 48A is directed to the eye 45 of the viewer by the alternative embodiment of optical apparatus 50A. Light rays 37B are transmitted through the guide facets 176, 178 without deflection such that the first optical apparatus 50A does not provide optical power to the received light ray 37 corresponding to the second image 30B.

By way of comparison with the embodiment of FIG. 2A, the embodiment of FIG. 16A provides extraction features 170 that may be manufactured at reduced cost and complexity.

In comparison to the embodiment of FIG. 1 illustrated in FIG. 5A, in the alternative embodiment of FIG. 16A, the polarisation state from the spatial light modulator 48A has a polarisation state 902A (191) in the first direction, a polarisation state 904A (193) in the second direction 193 and an output polarisation state 904A (199) towards the eye 45. The non-anamorphic second illumination system 102B (not shown) outputs the polarisation state 904B (199) to the eye 45 (not shown) that is transmitted through the primary guide facet 176 and guide portions 178, and through the polarisation-sensitive reflector 700 of the optical system 50A.

Anamorphic near-eye display devices that are similar in structure to the first illumination system 102A of FIGS. 16A-B, and alternative embodiments therein and operation thereof are described in further detail in U.S. Patent Publ. No. 2024-0061248 (Atty. Ref. No. 493001), which is herein incorporated by reference in its entirety.

Alternative anamorphic illumination apparatuses 102A comprising extraction features 170 disposed internally to the waveguide 1 will now be described.

FIG. 17A is a schematic diagram illustrating a rear perspective view of an alternative anamorphic illumination system 102A wherein the extraction features 170 extend between the rear and front guide surfaces 6, 8; and FIG. 17B is a schematic diagram illustrating a rear perspective view of an alternative anamorphic illumination system 102A wherein the extraction features 170 are stepped and are arranged between the guide surfaces of the extraction waveguide 1. Features of the embodiments of FIGS. 17A-B not discussed in further detail may be assumed to correspond to the features with equivalent reference numerals as discussed above, including any potential variations in the features.

By way of comparison with the embodiments of FIG. 5A, in FIGS. 16A-B the polarisation-sensitive reflector 700 is omitted. Advantageously complexity of assembly of the optical apparatus 50A may be reduced.

In the alternative embodiments of illumination system 102A of FIG. 17A, the extraction waveguide 1 comprises an array 170 of extraction features 174A-E disposed internally within the extraction waveguide 1, the extraction features 174A-E being arranged to transmit light guided along the extraction waveguide 1 in the first direction 191 and to extract light guided along the extraction waveguide 1 in the second direction 193 towards an eye of a viewer, the array of extraction features 170 being distributed along the extraction waveguide 1 so as to provide exit pupil expansion for example as described in FIG. 6A-B.

The extraction features 174 may be provided by material interfaces between sections 175 of waveguide material. The material interfaces may comprise for example dichroic stacks, bonding material with refractive index different to the refractive index of the sections 175, or reflective polarisers. The extraction features 174 may comprise a reflectivity that is polarisation sensitive. In operation, light travelling in the first direction with polarisation state 902A is transmitted at least in part by the extraction features 174A-E and is incident on the light reversing reflector and polarisation conversion retarder 72 so that polarisation state 904A is reflected. Light returning along the waveguide 1 in the second direction 193 is at least partially reflected at the extraction features 174 as output light through the front guide surface. The extraction features 174 may have reflectivity that varies along the waveguide 1 to achieve improved uniformity across the eyebox 40 in the transverse direction 197 for example by varying the material stack or pattern at the interface of the extraction features 174A-E.

Light rays 37B from the second illumination system 102B (not shown) have a polarisation state 904B and are transmitted by the extraction features 174. Light rays 37B are transmitted through the waveguide 1 without deflection such that the first optical apparatus 50A does not provide optical power to the received light ray 37 corresponding to the second image 30B.

In the alternative embodiment of illumination system 102A of FIG. 17B, the extraction waveguide 1 comprises an array 170 of extraction features 177A-E disposed internally within the extraction waveguide 1, wherein the extraction features 177A-E are arranged as steps of an internal interface 179 in the second direction 193 along the waveguide 1.

The extraction features 177 and propagation of polarised input light 902A may be provided in a similar manner to that of FIG. 17A hereinabove. The structure of FIG. 17B may be more conveniently manufactured than that of FIG. 17A, advantageously reducing cost and complexity.

By way of comparison with the embodiment of FIG. 2A, the alternative embodiments of FIGS. 17A-B provide rear and front guide surfaces 6, 8 that are planar. Aberrations due to imperfections and parallelism of the rear and front guide surfaces 6, 8 during manufacture may be reduced and advantageously modulation transfer increased.

Anamorphic near-eye display devices that are similar in structure to the first illumination system 102A of FIGS. 17A-B, and alternative embodiments therein and operation thereof are described in further detail in U.S. Patent Publ. No. 2023-0418034 (Atty. Ref. No. 489001), which is herein incorporated by reference in its entirety.

Alternative anamorphic illumination apparatuses 102A comprising extraction features 170 arranged as steps on the rear light guide surface 6 will now be described.

FIG. 17C is a schematic diagram illustrating a rear perspective view of an alternative anamorphic illumination system 102A wherein the extraction features are stepped and are arranged on the rear guide surface of the extraction waveguide 1. Features of the embodiment of FIG. 17C not discussed in further detail may be assumed to correspond to the features with equivalent reference numerals as discussed above, including any potential variations in the features.

By way of comparison with FIGS. 17A-B, in the alternative embodiment of FIG. 17C the extraction features are arranged externally on the rear guide surface 6 of the waveguide 1.

In operation, light from the input end 2 is directed along the waveguide 1 in the first direction 191, guiding between the front guide surface 8 and intermediate facets 10 of the rear guide surface 6. The light rays are reflected from the light reversing reflector 140 in the second direction 193 and are incident on intermediate facets 10 and are guided along the waveguide until incidence on an extraction feature 12 that is a step. At the extraction feature 12, the light ray 37A is output by reflection towards the eye 45 (not shown). Light ray 37B from the second illumination system is transmitted through the intermediate facets 10. Advantageously the waveguide 1 may be manufactured with reduced cost and complexity to the waveguides 1 hereinabove.

Anamorphic near-eye display devices that are similar in structure to the first illumination system 102A of FIG. 17C, and alternative embodiments therein and operation thereof are described in further detail in U.S. Pat. No. 9,594,261 (Atty. Ref. No. 315001), which is herein incorporated by reference in its entirety.

It may be desirable to reduce the thickness of the near-eye display apparatus 100.

FIG. 18A is a schematic diagram illustrating a rear perspective view of a near-eye display apparatus 100 comprising an anamorphic illumination system 102A arranged to receive light from a further anamorphic illumination system 102B; and FIG. 18B is a schematic diagram illustrating a rear perspective view of a near-eye display apparatus 100 comprising an anamorphic illumination system 102A arranged to receive light from a further anamorphic illumination system 102B and a non-anamorphic illumination system 102C. Features of the embodiments of FIGS. 18A-B not discussed in further detail may be assumed to correspond to the features with equivalent reference numerals as discussed above, including any potential variations in the features.

By way of comparison with the embodiment of FIG. 1, the alternative embodiment of FIG. 18A illustrates that the first illumination system 102A comprises an optical apparatus 50A that has an optical axis 199A and positive optical power in lateral and transverse directions 195A, 197A that are perpendicular to each other and perpendicular to the optical axis 199A, and wherein the first optical apparatus 102A has anamorphic properties in the lateral and transverse directions 195A, 197A; and the second illumination system 102B comprises an optical apparatus 50B that has an optical axis 199B and positive optical power in lateral and transverse directions 195B, 197B that are perpendicular to each other and perpendicular to the optical axis 199B, and wherein the second optical apparatus 102B has anamorphic properties in the lateral and transverse directions 195B, 197B.

In the alternative embodiment of FIG. 18A, the first optical apparatus 50A is of the type illustrated in FIG. 15B and the second optical apparatus 50B is of the type illustrated in FIG. 17A for example, wherein the extraction mechanisms are different. Advantageously different extraction efficiencies may be achieved. The optical power of the second optical system 50B may be different to the optical power of the first optical system 50A to advantageously achieve the different optical properties described elsewhere herein. Furthermore, the near-eye display apparatus 100 may have reduced thickness and weight in comparison to the embodiment of FIG. 1.

In the alternative embodiment of FIG. 18A, the lateral axis 195A is parallel to the transverse axis 197B and the transverse axis 197A is parallel to the lateral axis 195B. Advantageously differences in lateral and transverse aberrations may be compensated.

In alternative embodiments, not illustrated, the first and second anamorphic illumination systems 102A, 102B may be arranged to transmit light from a non-anamorphic illumination system 102C of the type illustrated in FIG. 2B. The first and second optical apparatuses 50A, 50B do not provide optical power to the received light corresponding to a third image 30C from a third spatial light modulator 48C. Advantageously further improvements in image 31 performance may be achieved.

Various combinations of anamorphic optical apparatus 50 as described elsewhere herein may be provided. For example the anamorphic optical apparatus of FIG. 2A, FIG. 15B, FIG. 16A, and FIGS. 17A-C and other embodiments described herein may be provided for first and second illumination systems 102A, 102B. Advantageously near-eye display apparatus 100 properties may be optimised to achieve desirable performance with low added thickness.

In the alternative embodiment of FIG. 18B, a first optical apparatus 50A of a first illumination system 102A and of the type illustrated in FIG. 16A is arranged to receive light from a second illumination system 102B with second optical apparatus 50B of the type illustrated in FIG. 17A. Further the optical apparatuses 50A, 50B are arranged to receive light from a third illumination system 102C comprising the illumination system of FIG. 2B. Advantageously further improvement in image characteristics may be achieved with small additional thickness.

Alternative arrangements of the second optical system 50B will now be described.

FIG. 19A is a schematic diagram illustrating a side view of the operation of an alternative arrangement of near-eye display apparatus 100 comprising an anamorphic illumination system 102A arranged to receive light from a non-anamorphic illumination system 102B comprising a Fresnel lens 55 and clean-up polariser 90. Features of the embodiment of FIG. 19A not discussed in further detail may be assumed to correspond to the features with equivalent reference numerals as discussed above, including any potential variations in the features.

By way of comparison with FIG. 3 for example, the lens arrangement 52 comprises a Fresnel lens 55 that comprises a Fresnel surface 56A and a curved surface 56B. Advantageously the thickness of the lens arrangement 52 may be reduced. Clean-up polariser 90 may achieve improved contrast for the second image 30B.

FIG. 19B is a schematic diagram illustrating a side view of the operation of an alternative arrangement of near-eye display apparatus 100 comprising an anamorphic illumination system 102A arranged to receive light from a non-anamorphic illumination system 102B comprising a Pancake lens. Features of the embodiment of FIG. 19B not discussed in further detail may be assumed to correspond to the features with equivalent reference numerals as discussed above, including any potential variations in the features.

The spatial light modulator 48B comprises a retarder 221 such as a quarter waveplate arranged to convert linear polarisation state to a circular polarisation state. By way of comparison with FIG. 19A, the lens arrangement 52 comprises a pancake lens 58. The illustrative pancake lens 50B of FIG. 19B comprises meniscus lens 650A and plano-convex lens 650B. A half mirror 670 is arranged on the front side of the meniscus lens 650A and a reflective polariser 676 is arranged on the rear side of the plano-convex lens 650B. A retarder 672 such as a quarter waveplate is arranged to convert a linear polarisation state to a circular polarisation state is arranged between the half mirror 670 and reflective polariser 676. The pancake lens has a folded optical path as illustrated, arising from the reflection and transmission of polarised light within the pancake lens 58. Advantageously the optical aberrations are improved in comparison to the Fresnel lens of FIG. 19A. The total optical thickness from the pancake lens 58 to the spatial light modulator 48B is reduced, reducing the total system thickness. Pancake lenses 58 have efficiency that is less than 25%, typically much lower. The first illumination system 102A advantageously may provide substantially higher brightness for high dynamic range and the second illumination system 102B may provide reduced aberrations for high image fidelity.

An alternative arrangement of illumination system 102B will now be described.

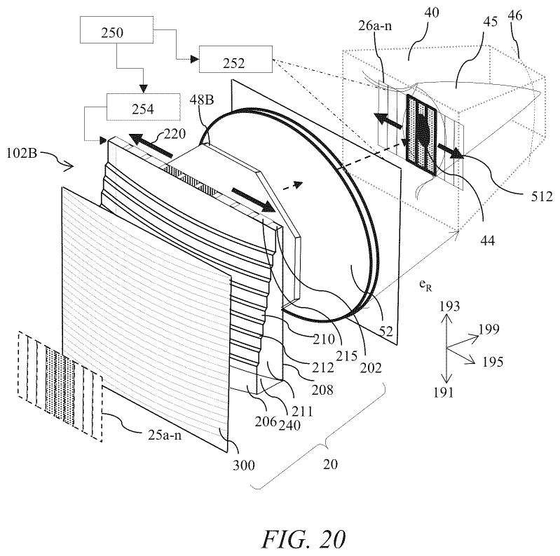

FIG. 20 is a schematic diagram illustrating in rear perspective view an alternative backlight arrangement for a non-anamorphic illumination system 102B comprising a transmissive spatial light modulator. Features of the embodiment of FIG. 20 not discussed in further detail may be assumed to correspond to the features with equivalent reference numerals as discussed above, including any potential variations in the features.

The alternative embodiment of FIG. 20 and alternative embodiments therein with extraction features 170 arranged within the extraction waveguide 1 is described in U.S. Pat. No. 11,966,049 (Atty. Ref. No. 494001), U.S. Pat. No. 9,519,153 (Atty. Ref. No. 281001), and U.S. Pat. No. 10,054,732 (Atty. Ref. No. 355001), all of which are herein incorporated by reference in their entireties.

By way of comparison with FIG. 1, backlight 20 is illustrated comprising a stepped waveguide 211. Stepped waveguide 211 comprises input end 202, a light reversing reflector 240, and rear and front light guide surfaces 206, 208. The rear light guide surface 206 comprises light extraction features 212 and intermediate facets 210. Light from an array of light sources 215 is input at the input side, passes in the first direction 191 without loss; is reflected at the light reversing reflector 240 and directed towards the extraction features 212 at which it is reflected as output light, or is directed towards a rear reflector 300, reflected and output back through the waveguide 211 as output light.

The backlight 20 provides virtual optical windows 25a-n that are illuminated in correspondence to the luminous flux output of the array of light sources 215. The virtual optical windows 25a-n are directed towards the eyebox 40 to provide control of the output illumination directed towards the eye 45. A sensor 252 is used to determine the driver 254 output that determines the illumination profile from the array of light sources by means of a control system 250.

Stepped waveguide 211 is different to the stepped waveguide 1 of FIG. 17C in that it is arranged to illuminate the transmissive spatial light modulator 48B and does not provide image data to the eye 45, rather it provides a profile of output illumination. Advantageously high brightness output can be achieved by the spatial light modulator 48B with high efficiency.

Arrangements wherein the first optical apparatus 50A comprises a non-anamorphic illumination system 702A will now be described.

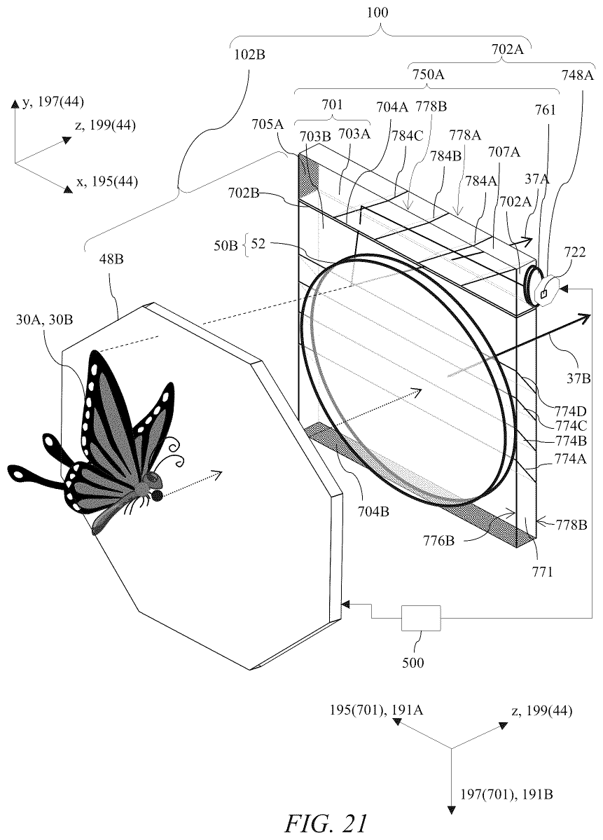

FIG. 21 is a schematic diagram illustrating a rear perspective view of a near-eye display apparatus 100 comprising a first non-anamorphic illumination system 702A comprising an optical apparatus 750A with internal extraction features 774A-D arranged to receive light from a second non-anamorphic illumination system 102B. Features of the embodiment of FIG. 21 not discussed in further detail may be assumed to correspond to the features with equivalent reference numerals as discussed above, including any potential variations in the features.

By way of comparison with FIG. 1, the alternative embodiment of FIG. 21 illustrates a near-eye display apparatus 100 comprising: a first illumination system 702A comprising a first spatial light modulator 748A and a first optical apparatus 750A, wherein the first spatial light modulator 748A is arranged to output light via the first optical apparatus 750A to provide a first image 30A for display, for example by means of rays 37A.

The first optical apparatus 750A has an optical axis 199 and positive optical power in lateral and transverse directions 195, 197 that are perpendicular to each other and perpendicular to the optical axis 199. By way of comparison to the illumination system 102A of FIG. 2A, the embodiment of FIG. 21 has optical power that is the same in the lateral and transverse directions and is provided by lens 761 arranged to provide image of the spatial light modulator 748A.

The waveguide 701 comprises first light guiding portion 703A and second light guiding portion 703B.

Input light from the lens 761 is input through the input side 702A of the first light guiding portion 703A and is guided between the front and rear guide surfaces 776A, 778A, top guide surface 707A and output guide surface 702B towards reflective deflection features 784A-C that extend between the front and rear guide surfaces 776A, 778A. By way of comparison with FIG. 2A, pupil expansion in the lateral direction 195 is provided by the reflective deflection features 784A-C.

Deflected light is output through the output guide surface 704A and into the input side 702B of the second light guiding portion 703B.

In the second light guiding portion 703B, light from the input side 702B is guided between the front and rear guide surfaces 776B, 778B, towards reflective extraction features 774A-D that extend between the front and rear guide surfaces 776B, 778B. Extracted light is output through the front guide surface 778B towards the eye 45 (not shown). By way of comparison with FIG. 2A, light extraction from the waveguide portion 703B is for light propagating in the first direction 191.

Absorbing material may be provided at an end 705A of the first waveguide portion 703A and at the end 704B of the second waveguide portion 703B. Advantageously stray light may be reduced.

The second illumination system 102B comprises a second spatial light modulator 48B and a second optical apparatus 50B, wherein the second spatial light modulator 48B is arranged to output light via the second optical apparatus 50B to provide a second image 30B for display for example as illustrated by rays 37B. The second optical apparatus 50B has positive optical power for the light output by the second spatial light modulator 48B, wherein the first illumination system 102A is arranged to receive, from the second illumination system 102B, light corresponding to the second image 30B and to permit the received light corresponding to the second image 30B to pass therethrough for display.

The first image provided by the first spatial light modulator and first optical apparatus has an angular resolution that is different to an angular resolution of the second image provided by the second spatial light modulator and second optical apparatus. More generally, the first image 30A provided by the first spatial light modulator 48A and first optical apparatus 50A has a property that is different to a property of the second image 30B provided by the second spatial light modulator 48B and second optical apparatus 50B wherein the property is at least one of: (i) image resolution; (ii) image content (iii) brightness; (iv) exit pupil size; (v) modulation transfer function; (vi) field of view; (vii) focal plane distance; (viii) response speed; (ix) pixel arrangement; and (x) colour gamut.

Arrangements wherein the first optical apparatus 50A comprises a non-anamorphic waveguide comprising diffractive extraction features 170 will now be described.

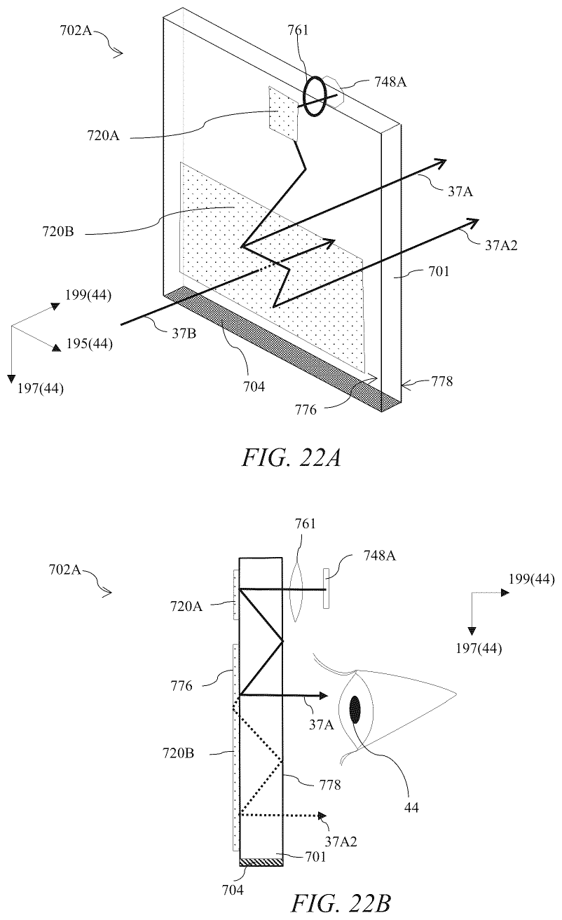

FIG. 22A is a schematic diagram illustrating a rear perspective view of a near-eye display apparatus 100 comprising a first non-anamorphic illumination system 702A comprising an optical apparatus 750A with diffractive features 720A, 702B arranged to receive light from a second non-anamorphic illumination system 102B; and FIG. 22B is a schematic diagram illustrating a side view of the operation of the first illumination system 702A of FIG. 22A. Features of the embodiment of FIGS. 22A-B not discussed in further detail may be assumed to correspond to the features with equivalent reference numerals as discussed above, including any potential variations in the features.

By way of comparison with FIG. 21, the alternative embodiment of FIGS. 22A-B comprises diffractive input feature 720A and diffractive extraction feature 720B. In operation, input light from lens 761 is directed towards diffractive input feature 720A and guided between the rear and front light guide surfaces 776, 778 of the waveguide 701. Partially reflective diffractive extraction feature 720B provides pupil 40 expansion through multiple extraction locations with output light rays 37A, 37A2.

The manufacture of the illumination system 702A may advantageously be provided at low cost. Further the visibility of non-uniformities across the exit pupil 40 may be reduced.

Head-worn display apparatuses 600 will now be described.

FIG. 23A is a schematic diagram illustrating in rear view a head-worn display apparatus 600 comprising a left-eye near-eye display apparatus 100L and a right-eye near-eye display apparatus 100R and a head-mounting arrangement 602; and FIG. 23B is a schematic diagram illustrating in rear view a head-worn display apparatus 600 comprising a left-eye near-eye display apparatus 100L and a right-eye near-eye display apparatus 104 and a head-mounting arrangement 602 wherein light from external scenes is transmitted through the display apparatus 104 and the head-mounting arrangement 602. Features of the embodiments of FIGS. 23A-B not discussed in further detail may be assumed to correspond to the features with equivalent reference numerals as discussed above, including any potential variations in the features.

The head-worn display apparatus 600 comprises: the near-eye display apparatus 100 of any preceding embodiments or alternatives therein; and a head-mounting arrangement 602 for mounting the near-eye display apparatus 100 on the head of a user 47.

In the embodiment of FIG. 23A, the head-worn display apparatus 600 comprises left-eye and right-eye near-eye display apparatuses 100L, 100R respectively. Cameras 604L, 604R may further be provided to record pass-through image data of the outside world as described further hereinabove, for example with respect to FIGS. 10G-H or FIG. 12.

In the alternative embodiment of FIG. 23B, an aperture 606 is arranged to transmit light from external scenes, and further the near-eye display device 104 is transmissive to light from external scenes. Display device 104 may for example comprise illumination systems 102 of the types illustrated in FIG. 2A, FIGS. 16A-B, FIGS. 17A-C, FIG. 21 or FIGS. 22A-B or near-eye display apparatus of the type or alternatives therein illustrated in FIG. 18A. Advantageously at least one of cameras 604L, 604R may be omitted to achieve improved visibility of external scenes and improve user 47 safety. In an alternative embodiment, a shutter (not shown) such as a mechanical shutter or a liquid crystal shutter may be provided to block or reduce light from the external scene passing through the illumination apparatus 104 to the right eye 45R. Switching between a virtual reality mode of operation and an augmented reality mode of operation may be provided.

While various embodiments in accordance with the principles disclosed herein have been described above, it should be understood that they have been presented by way of example only, and not limitation. Thus, the breadth and scope of this disclosure should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the embodiment(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any embodiment(s) in this disclosure. Neither is the “Summary” to be considered as a characterization of the embodiment(s) set forth in issued claims. Furthermore, any reference in this disclosure to “invention” in the singular should not be used to argue that there is only a single point of novelty in this disclosure. Multiple embodiments may be set forth according to the limitations of the multiple claims issuing from this disclosure, and such claims accordingly define the embodiment(s), and their equivalents, that are protected thereby. In all instances, the scope of such claims shall be considered on their own merits in light of this disclosure, but should not be constrained by the headings set forth herein.

1. A near-eye display apparatus comprising:
a first illumination system comprising a first spatial light modulator and a first optical apparatus, wherein the first spatial light modulator is arranged to output light via the first optical apparatus to provide a first image for display, wherein the first optical apparatus has an optical axis and positive optical power in lateral and transverse directions that are perpendicular to each other and perpendicular to the optical axis, and wherein the first optical apparatus has anamorphic properties in the lateral and transverse directions; and
a second illumination system comprising a second spatial light modulator and a second optical apparatus, wherein the second spatial light modulator is arranged to output light via the second optical apparatus to provide a second image for display, and wherein the second optical apparatus has positive optical power for the light output by the second spatial light modulator,
wherein the first illumination system is arranged to receive, from the second illumination system, light corresponding to the second image and to permit the received light corresponding to the second image to pass therethrough for display, and
wherein the first image provided by the first spatial light modulator and first optical apparatus has at least one property that is different to the second image provided by the second spatial light modulator and second optical apparatus,
wherein said at least one property comprises at least one of:
image resolution;
image content;
brightness;
exit pupil size;
modulation transfer function;
field of view;
focal plane distance;
response speed;
pixel arrangement; and
colour gamut.

2. The near-eye display apparatus according to claim 1, wherein the first optical apparatus does not provide optical power to the received light corresponding to the second image.

3. The near-eye display apparatus according to claim 1, wherein the first optical apparatus comprises an extraction waveguide.

4. The near-eye display apparatus according to claim 1, wherein the second optical apparatus has non-anamorphic properties in the lateral and transverse directions.

5. The near-eye display apparatus according to claim 1, wherein the second optical apparatus comprises a lens arrangement.

6. The near-eye display apparatus according to claim 3, wherein:
the first spatial light modulator comprises first pixels distributed in the lateral direction, and
the first optical apparatus comprises:
a transverse anamorphic component having positive optical power in the transverse direction, wherein the transverse anamorphic component is arranged to receive light from the first spatial light modulator and to output light in directions that are distributed in the transverse direction, wherein the extraction waveguide is arranged to receive the light output from the transverse anamorphic component;
a lateral anamorphic component having positive optical power in the lateral direction, wherein the extraction waveguide is arranged to guide light from the transverse anamorphic component to the lateral anamorphic component along the extraction waveguide in a first direction; and
a light reversing reflector that is arranged to reflect light guided along the extraction waveguide in the first direction such that the reflected light is directed along the extraction waveguide in a second direction opposite to the first direction.

7. The near-eye display apparatus according to claim 6, wherein:
the extraction waveguide comprises a rear guide surface and a polarisation-sensitive reflector opposing the rear guide surface;
the first illumination system further comprises a deflection arrangement disposed outside the polarisation-sensitive reflector,
the first illumination system is arranged to provide light guided along the extraction waveguide in the first direction with an input linear polarisation state before reaching the polarisation-sensitive reflector;
the first optical apparatus further comprises a polarisation conversion retarder disposed in the light path between the polarisation-sensitive reflector and the light reversing reflector, wherein the polarisation conversion retarder is arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has a linear polarisation state that is orthogonal to the input linear polarisation state;
the polarisation-sensitive reflector is arranged to reflect light guided in the first direction having the input linear polarisation state so that the rear guide surface and the polarisation-sensitive reflector are arranged to guide light in the first direction, and to extract light guided in the second direction having the orthogonal linear polarisation state so that the extracted light is incident on the deflection arrangement; and
the deflection arrangement is arranged to deflect at least part of the light extracted by the polarisation-sensitive reflector that is incident thereon towards an output direction forwards of the first illumination system.

8. The near-eye display apparatus according to claim 6, wherein:
the extraction waveguide comprises:
a front guide surface;
a polarisation-sensitive reflector opposing the front guide surface; and
an extraction element disposed outside the polarisation-sensitive reflector,
the extraction element comprising:
a rear guide surface opposing the front guide surface; and
an array of extraction features;
the first illumination system is arranged to provide light guided along the extraction waveguide in the first direction with an input linear polarisation state before reaching the polarisation-sensitive reflector; and
the first optical apparatus further comprises a polarisation conversion retarder disposed between the polarisation-sensitive reflector and the light reversing reflector, wherein the polarisation conversion retarder is arranged to convert a polarisation state of light passing therethrough between a linear polarisation state and a circular polarisation state, and the polarisation conversion retarder and the light reversing reflector are arranged in combination to rotate the input linear polarisation state of the light guided in the first direction so that the light guided in the second direction and output from the polarisation conversion retarder has an orthogonal linear polarisation state that is orthogonal to the input linear polarisation state;
the polarisation-sensitive reflector is arranged to reflect light guided in the first direction having the input linear polarisation state and to extract light guided in the second direction having the orthogonal linear polarisation state, so that the front guide surface and the polarisation-sensitive reflector are arranged to guide light in the first direction, and the front guide surface and the rear guide surface are arranged to guide light in the second direction; and
the array of extraction features is arranged to extract light guided along the extraction waveguide in the second direction towards an eye of a viewer through the front guide surface, the array of extraction features being distributed along the extraction waveguide so as to provide exit pupil expansion in the transverse direction.

9. The near-eye display apparatus according to claim 6, wherein:
the extraction waveguide comprises an array of extraction features disposed internally within the extraction waveguide, the extraction features being arranged to transmit light guided along the extraction waveguide in the first direction and to extract light guided along the extraction waveguide in the second direction towards an eye of a viewer, the array of extraction features being distributed along the extraction waveguide so as to provide exit pupil expansion.

10. The near-eye display apparatus according to claim 8, wherein the array of extraction features comprises a reflectivity that is polarisation sensitive.

11. The near-eye display apparatus according to claim 1, wherein the output polarisation state of light from the first optical apparatus is orthogonal to the output polarisation state of light from the second optical apparatus.

12. The near-eye display apparatus according to claim 4, wherein the lens arrangement comprises a Fresnel lens.

13. The near-eye display apparatus according to claim 4, wherein the lens arrangement comprises a pancake lens.

14. The near-eye display apparatus according to claim 1, wherein the first spatial light modulator comprises first pixels.

15. The near-eye display apparatus according to claim 14, wherein the first pixels are inorganic micro-LED pixels or OLED pixels.

16. The near-eye display apparatus according to claim 1, wherein the second spatial light modulator comprises second pixels.

17. The near-eye display apparatus according to claim 16, wherein the second pixels are OLED pixels.

18. The near-eye display apparatus according to claim 16, wherein the second pixels are liquid crystal display pixels.

19. The near-eye display apparatus according to claim 16, wherein an aspect ratio of the first pixels is different to an aspect ratio of the second pixels.

20. The near-eye display apparatus according to claim 1, wherein a virtual image distance provided by the first optical apparatus is different to a virtual image distance provided by the second optical apparatus.

21. A head-worn display apparatus comprising:
the near-eye display apparatus according to claim 1; and
a head-mounting arrangement for mounting the near-eye display apparatus on the head of a user.
